(19) United States
(12) Patent Application Publication
(10) Pub. No.: US 2019/0078696 A1
(43) Pub. Date: Mar. 14, 2019

(54) FLUID SUPPLY PACKAGE

(71) Applicant: Entegris, Inc., Billerica, MA (US)

(72) Inventors: Glenn M. Tom, BETHANY BEACH, DE (US); Karl W. Olander, INDIAN SHORES, FL (US); James A. Dietz, SAN JOSE, CA (US); Michael J. Wodjenski, NEW MILFORD, CT (US); Edward A. Sturm, NEW MILFORD, CT (US); Susan K. Dimascio, NEW MILFORD, CT (US); Luping Wang, Jiangsu (CN); James V. McManus, BETHEL, CT (US); Steven M. Lurcott, DEERFIELD BEACH, FL (US); Jose I. Amo, PORTLAND, OR (US); Paul J. Marganski, SEYMOUR, CT (US); Joseph D. Sweeney, NEW MILFORD, CT (US); Shaun M. Wilson, TRUMBULL, CT (US); Steven E. Bishop, CORRALES, NM (US); Greg Nelson, MINNEAPOLIS, MN (US); Donald J. Carruthers, RENO, NV (US); Sharad N. Yedave, DANBURY, CT (US); Ying Tang, BROOKFIELD, CT (US); Joseph Despres, MIDDLETOWN, CT (US); Barry Chambers, MIDLOTHIAN, VA (US); Richard Ray, PHOENIX, AZ (US); Daniel Elzer, GILBERT, AZ (US)

(21) Appl. No.: 15/743,109

(22) PCT Filed: Jul. 8, 2016
(86) PCT No.: PCT/US2016/041578

§ 371 Date: Jan. 9, 2018

Related U.S. Application Data
(60) Provisional application No. 62/190,529, filed on Jul. 9, 2015.

(51) Int. Cl. F16K 17/00; F16K 17/04; F16K 31/00; F16K 31/06; F17C 13/04

(52) U.S. Cl. CPC F16K 17/003; F16K 17/04; F16K 31/002; F17C 2270/0518; F17C 13/04; F17C 2205/0338; F17C 2205/0391; F16K 31/0675

(57) ABSTRACT

Fluid supply packages of varying types are described, which are useful for delivery of fluids to fluid-utilizing facilities such as semiconductor manufacturing facilities, solar panel manufacturing facilities, and flat-panel display manufacturing facilities. The fluid supply packages include fluid supply vessels and valve heads of varied configuration, as useful to constitute fluid supply packages that are pressure-regulated and/or adsorbent-based in character.

### FIELD

The present disclosure relates to fluid supply packages having utility for storage and dispensing of gases, e.g., gases that are utilized in manufacture of semiconductor, photovoltaic, and flat-panel display products.

### DESCRIPTION OF THE RELATED ART

In the manufacture of semiconductor products, photovoltaic panels, and flat-panel displays, a wide variety of fluids is utilized. Such fluids include precursors that are utilized for deposition of metals, metalloids, and intermetallic materials, dopant source materials that are subjected to ionization for ion implantation operations, gases that are utilized as carriers for other reagents, and etchants, cleaning fluids and planarization agents that are used for materials removal.

In the supply of these fluids, a corresponding variety of packages have been developed. These packages include adsorbent-based fluid supply packages in which a fluid supply vessel contains an adsorbent storage medium for adsorptive retention of gas that is desorbed from the adsorbent under dispensing conditions. Adsorbent-based fluid supply packages of such type include packages commercially available from Entegris, Inc., Billerica, Mass., USA under the trademarks SDS, PDS, and SAGE. Fluid supply packages have also been developed that are pressure-regulated, in which a fluid supply vessel contains one or more pressure regulator devices in the gas dispensing flow path, for dispensing of fluid at pressure that is controlled by the interiorly disposed pressure regulators. Pressure-related packages of such type include packages commercially available from Entegris, Inc., Billerica, Mass., USA under the VAC trademark. Fluids may also be supplied for use in the foregoing applications as gases produced by sublimation of solid source materials that are provided in solid source delivery packages that are heated to generate the product gas for dispensing. Solid source delivery packages of such type are commercially available from Entegris, Inc., Billerica, Mass., USA under the trademarks under the trademark ProE-Vap.

Under the impetus of ongoing developments in the field of chemical reagents development for the foregoing manufacturing applications, and the necessity of supplying chemical reagents in a safe, reliable, and maximally efficient manner for these applications, the art continues to seek new and improved fluid supply packages.

### SUMMARY

The present disclosure relates to fluid supply packages having utility for storage and dispensing of gases, e.g., gases that are utilized in manufacture of semiconductor, photovoltaic, and flat-panel display products.

In one aspect, the disclosure relates to a pressure regulated fluid supply package, comprising a fluid supply vessel coupled to a valve head and arranged to dispense pressure-controlled gas, wherein an adjustable gas pressure control device and a dispensing control assembly are disposed in an interior volume of the fluid supply vessel, the dispensing control assembly comprising a controller configured to adjust the adjustable gas pressure control device in response to inputted control signals, a rechargeable power supply configured to power the controller, and an internal magnetic drive configured to generate electrical energy for charging of the rechargeable power supply in response to interaction with an external magnetic drive.

In another aspect, the disclosure relates to a fluid supply package that includes a pressure-regulated compartment in fluid communication with an adsorbent-based compartment of a unitary fluid supply vessel that is coupled with a valve head for dispensing of fluid from the adsorbent-based compartment at predetermined pressure, wherein the pressure-regulated compartment includes one or more pressure regulators therein configured so that a regulator thereof is in direct flow communication with the adsorbent-based compartment.

A further aspect of the disclosure relates to a fluid supply package comprising a fluid supply vessel containing an interiorly disposed fluid dispensing stick assembly including at least one pressure regulator upstream of which is a check valve, wherein the at least one pressure regulator and check valve are configured to enable the fluid dispensing stick assembly to dispense gas from the fluid supply vessel at flow rate in a range of from 2 to 35 standard liters per minute.

A still further aspect of the disclosure relates to a fluid supply package including multiple sub-packages of fluids from which are delivered respective fluids, for mixing in the package and dispensing therefrom of a fluid mixture, wherein the mixing is carried out in a mixing manifold or with a dedicated mixing chamber from which the fluid mixture passes to a dispensing valve of the fluid supply package for dispensing for use.

Another aspect of the disclosure relates to a fluid supply package comprising a vessel coupled to a valve head, wherein the vessel contains adsorbent comprising multiple sorbent species, each having selective sorptive affinity for a specific one of respective multiple gas components, so that the respective adsorbent species under dispensing conditions will desorb gas components to form a corresponding gas mixture at a predetermined composition of the respective gas components.

In a further aspect, the disclosure relates to a method of packaging a low grade dopant in an adsorbent-based fluid supply package, said method comprising charging the adsorbent with low grade dopant gas so that all or substantially all of the available adsorption capacity of the adsorbent is consumed by the dopant gas in the low grade dopant gas.

The disclosure in another aspect relates to a thermal management assembly arranged to increase fluid inventory and supplied fluid from an adsorbent-based fluid supply package, the thermal management assembly including a thermal management housing defining a cavity in which the adsorbent-based fluid supply package is disposed during charging of fluid to a fluid supply vessel of the fluid supply package, wherein the fluid supply vessel contains adsorbent having sorptive affinity for the charged fluid, the thermal management housing being configured to provide a convective flow gap between an inner surface of the housing and an outer surface of the fluid supply vessel of the fluid supply package when the fluid supply package is mounted in the cavity, with a heating jacket mounted on the thermal management housing, and the heating jacket surrounded by an insulation jacket, with a vortex cooler coupled with the convective flow gap to generate cold gas for flow through the convective flow gap for cooling of the fluid supply package and the adsorbent in the fluid supply vessel thereof, so that an increased volume of fluid can be charged to the vessel adsorbed on the adsorbent therein, in relation to a corresponding vessel at ambient temperature, and wherein the thermal management assembly is configured for heating of the vessel and adsorbent therein by actuating of the heating jacket and/or flow of hot gas from the vortex cooler through the convective flow gap when the fluid supply package during dispensing operation dispenses gas at a predetermined dispensing condition indicative of exhaustion of fluid inventory, whereby heating of the vessel and adsorbent therein enables the dispensing from the vessel of at least part of residual fluid of the fluid inventory.

A further aspect of the disclosure relates to an adsorbent-based fluid supply package for subatmospheric pressure dispensing of gas, comprising a fluid supply vessel that is coupled with a valve head including a discharge port for dispensing gas from the vessel, wherein the fluid supply vessel contains an adsorbent in an interior volume of the vessel, the adsorbent having sorptive affinity for gas that is adsorbed on and subsequently desorbed from the adsorbent for the dispensing of the gas from the vessel, the package further comprising a backflow and overpressure leakage protection assembly, comprising at least one of (i) a regulator or check valve in the interior volume of the vessel through which gas flows for dispensing from the vessel, and (ii) a regulator or check valve coupled to the discharge port of the valve head for flow of dispensed gas from the discharge port therethrough, wherein the regulators and check valves are configured to prevent back flow into the vessel and overpressure leakage of gas from the vessel.

The disclosure relates in one aspect to a fluid supply package comprising a fluid supply vessel coupled to a valve head including a discharge port configured for dispensing gas from the package, in which the fluid supply vessel includes in an interior volume thereof a fluid dispensing assembly comprising one or more pressure regulator device(s), in a series arrangement when more than one such device is present, and a capillary tube assembly upstream of the pressure regulator device(s) comprising capillary tubes through which gas is flowed to the pressure regulator device(s), so that gas flows from the pressure regulator device(s) to the valve head for dispensing at a discharge port thereof, and wherein the interior volume of the fluid supply vessel also contains adsorbent as a storage medium for the gas, on which the gas is stored and from which gas is desorbed under dispensing conditions.

In a further aspect, the disclosure relates to a leak prevention assembly for use in an adsorbent-based fluid supply package employed to dispense gas, said leak prevention assembly being configured for placement upstream of a dispensing valve of said fluid supply package, and comprising a flow control housing including an inlet and outlet for flow of gas therethrough, with a poppet coupled to a bellows assembly that is pressure-responsive in an overpressure condition to translate the poppet to close the outlet of the flow control housing and prevent overpressure gas from being flowed to the dispensing valve and expelled from the fluid supply package when the dispensing valve is open.

Another aspect of the disclosure relates to a leak prevention assembly for use in an adsorbent-based fluid supply package employed to dispense gas, said leak prevention assembly being configured for placement upstream of a dispensing valve of said fluid supply package to prevent dispensing of gas from the fluid supply package, and comprising a flow control housing including an inlet and outlet for flow of gas therethrough, with a poppet coupled by an expansible memory material device to a bellows assembly that is responsive only when both an overpressure condition and an over-temperature condition exist, to translate the poppet to close the outlet of the flow control housing and prevent gas from being flowed to the dispensing valve and expelled from the fluid supply package when the dispensing valve is open.

In an additional aspect, the disclosure relates to a fluid supply package including a pressure-regulated fluid supply vessel coupled to a valve head for dispensing of gas at a predetermined pressure level, comprising a gas dispensing assembly in an interior volume of the fluid supply vessel, and a pressure monitoring and shutoff assembly coupled with the gas dispensing assembly in the interior volume of the vessel and configured to prevent dispensing in an overpressure condition exceeding a predetermined pressure.

In yet another aspect, the disclosure relates to a fluid supply package comprising a pressure-regulated fluid supply vessel coupled to a valve head, wherein the pressure regulated fluid supply vessel contains in an interior volume of the vessel a fluid dispensing assembly comprising a series arrangement of pressure regulators, in which the regulators are configured to provide dispensed fluid from the fluid supply package at pressure at or slightly above atmospheric pressure, thereby obviating the need for a vacuum process or pump to boost the dispensed gas pressure and drive the gas flow, and wherein a restrictive flow orifice is optionally provided in a gas flow passage of a valve in the valve head of the fluid supply package.

A further aspect of the disclosure relates to a fluid supply package of a type selected from the group consisting of adsorbent-based fluid supply packages, pressure-regulated fluid supply packages, and adsorbent-based and concurrently pressure-regulated fluid supply packages, the fluid supply package comprising a fluid supply vessel coupled to a valve head configured for dispensing gas from the fluid supply vessel in dispensing operation of the fluid supply package, and the fluid supply package containing co-packaged implant dopant gases in the fluid supply vessel, wherein the co-packaged implant dopant gases do not include elements in respective gases that will result in cross-contamination in ion implantation operation utilizing gas dispensed from the fluid supply package.

In another aspect, the disclosure relates to a fluid supply package comprising multiple sub-vessels in a fluid supply package vessel, one of said multiple sub-vessels containing an ion implantation dopant source gas, and another of said multiple sub-vessels containing a cleaning gas, wherein the sub-vessels are each configured to dispense gas independently of the others.

The disclosure relates in a further aspect to a fluid supply package including a pressure-regulated fluid supply vessel coupled to a valve head for dispensing of gas at a predetermined pressure level, and comprising a gas dispensing assembly in an interior volume of the fluid supply vessel, the gas dispensing assembly comprising a gas stick defining a gas flow path including at least one flow control device, wherein an upper portion of the gas stick is coaxial with the fluid supply vessel and a lower portion of the gas stick comprises a conduit that is angled away from the coaxial upper portion of the gas stick and is coupled at a lower end thereof to a gas-permeable membrane for occlusion of particles from gas flowed through the gas stick for dispensing from the fluid supply package.

In yet another aspect, the disclosure relates to a point of use generation system for generating a gaseous reagent, the system comprising a fluid supply package including a fluid supply vessel coupled to a valve head for dispensing of gas, the fluid supply vessel containing a reactant material for the gaseous reagent, the valve head of the fluid supply package being coupled by flow circuitry with (i) a source of carrier gas and/or (ii) a source of co-reactant(s) that are reactive with the reactant material in the fluid supply vessel, and optionally with (iii) an ancillary reaction chamber arranged to receive dispensed gas from the fluid supply vessel and to reactively generate the gaseous reagent, with the point of use generation system being configured for reacting co-reactant(s) with the reactant material either in the fluid supply vessel or in the ancillary reaction chamber.

A further aspect of the disclosure relates to a fluid supply package for deployment in an environment susceptible to sudden heat and/or fire events, said fluid supply package comprising a fluid supply vessel coupled to a valve head, and an insulative cover on the fluid supply vessel and the valve head, which is effective to maintain the fluid supply package for an extended period of time without rupture in the event of a fire or other high temperature exposure.

In a related aspect, the disclosure relates to a gas box assembly for holding fluid supply packages to dispense gases an ion implanter apparatus, said gas box assembly comprising a gas box, and an insulative cover on the gas box, which is effective to maintain the gas box for an extended period of time without rupture of fluid supply packages therein, in the event of a fire or other high temperature exposure.

Another aspect of the disclosure relates to a fluid supply package comprising a fluid supply vessel coupled to a valve head arranged for dispensing gas from the fluid supply vessel, an overpressure sensor configured to detect an overpressure condition of fluid in the fluid supply package and responsively output an overpressure condition signal, and a protective closure valve that is configured to close in response to the overpressure condition signal from the overpressure sensor.

A further aspect of the disclosure relates to a fluid supply package, comprising a fluid supply vessel coupled to a valve head, the valve head including a fluid discharge port to discharge fluid from the fluid supply vessel, and a flow control occlusion device leak-tightly and removably installed in the fluid discharge port, to prevent flow communication of the fluid discharge port with an external source of fluid.

In another aspect, the disclosure relates to a fluid supply package comprising a fluid supply vessel coupled to a valve head for dispensing of fluid from the fluid supply vessel, wherein the valve head comprises a pneumatic valve and is dimensionally sized to enable placement of the fluid supply package in an ion implanter gas box.

A further aspect of the disclosure relates to a fluid supply package, comprising a fluid supply vessel coupled to a valve head and regulator assembly for dispensing of fluid from the vessel, the valve head and regulator assembly comprising an external adjustable pressure regulator and a dispensing valve communicating with a discharge port, arranged so that during dispensing the fluid flows through the external adjustable pressure regulator prior to flow through the dispensing valve of the assembly to the discharge port, and the fluid supply vessel having internally disposed therein a gas stick comprising at least one pressure regulator or pressure actuated check valve and arranged to flow gas from the fluid supply vessel to the valve head and regulator assembly.

In a further aspect, the disclosure relates to an internally pressure regulated fluid supply package configured to attenuate fluid output spiking and oscillation behavior, said fluid supply package comprising a fluid supply vessel coupled to a valve head including a discharge port for dispensing of fluid from the vessel, the fluid supply vessel having internally disposed therein a gas stick comprising at least one pressure regulator or pressure actuated check valve and arranged to flow gas from the fluid supply vessel to the valve head, wherein: (i) a pressure regulator or pressure actuated check valve that is located prior to any other pressure regulator or pressure actuated check valve in the gas stick is set so that its delivery pressure is below a delivery pressure at which fluid output spiking and oscillation behavior can occur, and/or (ii) the fluid supply package comprises at least one external pressure regulator, which is (A) integrated with the valve head in a valve head and regulator assembly comprising the external adjustable pressure regulator and the valve head, arranged so that during dispensing the fluid flows through the external adjustable pressure regulator prior to flow through the valve head in the assembly, or (B) coupled to the discharge port of the valve head.

Other aspects, features and embodiments of the disclosure will be more fully apparent from the ensuing description and appended claims.

### BRIEF DESCRIPTION OF THE DRAWINGS

FIG. 1 is a schematic representation of a fluid supply package according to one aspect of the present disclosure.

FIG. 2 is a schematic elevation view of a fluid supply package according to one aspect of the disclosure, wherein the fluid supply vessel is shown in partial breakaway view to illustrate details of the internal construction thereof, and with the fluid supply package being integrated with a fluid monitoring and control assembly.

FIG. 3 is a schematic elevation view of a fluid dispensing package according to another aspect of the disclosure, in which the vessel of the package is shown partially broken away to show the details of the fluid dispensing assembly in the interior volume of the vessel.

FIG. 4 is a schematic representation of a fluid supply package including a fluid supply package casing defining an interior volume within the casing in which is disposed a first fluid supply sub-package and a second fluid supply sub-package, for point of use formation of fluid mixtures for dispensing.

FIG. 5 is a schematic representation of a similar fluid supply package to that of FIG. 4, but wherein a dedicated mixing chamber is provided to effect homogeneity of the blended fluids from the first and second sub-packages.

FIG. 6 is a schematic representation of a fluid supply package comprising a fluid supply vessel leak tightly coupled to a valve head, in which the fluid supply vessel contains an adsorbent mixture comprising different adsorbents each having specific sorptive affinity for a particular component of a desired gas mixture.

FIG. 7 is an elevation view showing a fluid supply package mounted in a thermal management assembly, and arranged to substantially increase the fluid capacity of the fluid supply package.

FIG. 8 is a schematic representation of a fluid supply package equipped with backfill protection and leak protection features, according to one aspect of the disclosure.

FIG. 9 is an elevation view of a fluid supply package comprising a fluid supply vessel containing adsorbent and a gas dispensing assembly comprising a capillary tube assembly and pressure control device(s).

FIG. 10 is a schematic elevation view of a leak prevention assembly according to one embodiment of the disclosure.

FIG. 11 is a schematic elevation view of the leak prevention assembly of FIG. 10, in which the assembly has responded to an overpressure condition in the fluid supply vessel.

FIG. 12 is a schematic elevation view of a leak prevention assembly according to another embodiment of the disclosure, as configured to respond to simultaneous overpressure and over-temperature conditions in a fluid supply vessel of a fluid supply package.

FIG. 13 is a schematic elevation view of the leak prevention assembly of FIG. 12, in which the assembly has responded to simultaneous overpressure and over-temperature conditions in a fluid supply vessel of a fluid supply package.

FIG. 14 is a schematic elevation view of a fluid supply package in which the vessel is shown partially broken away to illustrate the structural details of the gas stick and a pressure monitoring and shutoff assembly operatively coupled to the gas stick.

FIG. 15 is a schematic elevation view of a fluid supply package configured for point of use generation of a product gaseous reagent, according to one embodiment of the present disclosure.

FIG. 16 is a schematic elevation view of a fluid supply package utilizing strain gauge overpressure sensors operatively linked with a protective valve that is responsive to overpressure signals from the strain gauge overpressure sensors, and functioning to close the fluid supply package to fluid communication and to interchange with an ambient environment of the package, in the event of an overpressure condition.

FIG. 17 is an elevation view of a fluid supply package including a fluid supply vessel coupled to a valve head including a discharge port, with a flow control occlusion device leak tightly installed in the fluid discharge port to prevent flow communication with the ambient environment of the package.

FIG. 18 is a schematic representation of a gas box system in which the fluid supply packages including low profile pneumatic valves are arranged for flowing dispensed gas to a downstream ion source of an ion implanter.

FIG. 19 is a schematic elevation view of a fluid supply package, partially broken away to show the details of the internal fluid dispensing stick, comprising a fluid supply vessel coupled with a valve head and regulator assembly in which the regulator in such assembly is external to the fluid supply vessel and externally adjustable to provide a selected set point for fluid dispensing. The details of an alternative embodiment are also shown in FIG. 19, as comprising an external pressure regulator in the flow circuitry coupled to the discharge port of the fluid supply package and a monitoring and control system adapted to adjust the adjustable regulator in the valve head and regulator assembly or the regulator in the downstream flow circuitry.

### DETAILED DESCRIPTION

The present disclosure relates to fluid supply packages useful for supplying gases for such applications as the manufacture of products such as semiconductor devices, solar panels, and flat-panel displays.

In one aspect, the disclosure relates to a pressure regulated fluid supply package, comprising a fluid supply vessel coupled to a valve head and arranged to dispense pressure-controlled gas, wherein an adjustable gas pressure control device and a dispensing control assembly are disposed in an interior volume of the fluid supply vessel, the dispensing control assembly comprising a controller configured to adjust the adjustable gas pressure control device in response to inputted control signals, a rechargeable power supply configured to power the controller, and an internal magnetic drive configured to generate electrical energy for charging of the rechargeable power supply in response to interaction with an external magnetic drive.

In such pressure regulated fluid supply package, the adjustable gas pressure control device may comprise an adjustable set point pressure regulator arranged so that gas from the fluid supply vessel flows through the pressure regulator and to the valve head for dispensing. The pressure regulated fluid supply package is advantageously employed in combination with an external magnetic drive assembly. In various embodiments, the controller may comprise a microprocessor that is configured to receive gas pressure control device adjustment instructions by input of information from the internal magnetic drive generated by interaction with the external magnetic drive.

The foregoing pressure regulated fluid supply package addresses the issue that in pressure-regulated fluid supply packages, in which one or more pressure regulators is interiorly disposed in a vessel to controllably dispense gas, the regulators are typically pre-set in character, to provide a specific set point pressure for enabling fluid flow through the regulator to take place. In consequence of their interior placement, these pressure regulators cannot be re-set to different set point pressures unless they are removed from the fluid supply vessel and adjusted to a new set point setting.

Thus, an electromechanical solution is provided, which obviates such adjustability issue.

In accordance with this aspect of the disclosure, a fluid supply package includes a dispensing control assembly, comprising an electronics module and an internal magnetic coupler/generator. The dispensing control assembly is disposed in the interior volume of the vessel of the fluid supply package. The internal magnetic coupler/generator is configured to be magnetically driven by an external magnetic drive unit disposed outside the vessel. A microprocessor, such as a process instrumentation controller or equivalent device, is provided in the electronics module, and configured to control a flow control device of the fluid supply package, and to read an input from an external source and a pressure transducer. The flow control device of the dispensing control assembly may be a variable flow control valve, a pressure regulator, a series arrangement of pressure regulators, or any other flow control device that can be modulated by a control signal to very pressure and/or flow rate characteristics of a fluid that is to be dispensed from the fluid supply package.

The flow control device will therefore have a set point that can be adjusted by external input. For example, the flow control device may comprise a poppet valve that is translatable between open and closed positions in response to a pressure condition at a fluid outlet of the flow control device in accordance with a set point mechanism of the device. The microprocessor of the dispensing control assembly may be configured with such device to modulate the position of the poppet element in the poppet valve to control the pressure at the fluid outlet of the poppet valve. For example, the dispensing control assembly may be arranged so that the microprocessor causes the poppet to open and close rapidly to modulate the pressure, or the poppet may be arranged to provide a continuously variable orifice to fluid flow. In any event, the poppet element in the absence of modulating input closes the poppet valve to flow.

In this fluid supply package, the internal magnetic drive provides two primary functions. As the external magnetic drive spins, the internal magnetic drive is caused to rotate in synchrony with the rotation of the external magnetic drive. The internal magnetic drive by virtue of its rotational motion provides power to the electronics module, e.g., by means of a power converter unit producing electrical energy which is coupled with a rechargeable battery, for recharging thereof so that the rechargeable battery is enabled to provide a continuous power output to the microprocessor of the electronics module. The microprocessor in turn is configured to modulate the flow control device to control the fluid dispensed from the fluid supply package. As a further function, the internal drive system may be configured to transmit information to the electronics module. For example, rotation rate or digital encoding can be employed to pass set point information to the microprocessor so that it responsively operates to adjust the set point of the flow control device.

The foregoing arrangement avoids any need for penetration of the vessel or valve head by control components such as mechanical linkages, signal transmission wires, or the like.

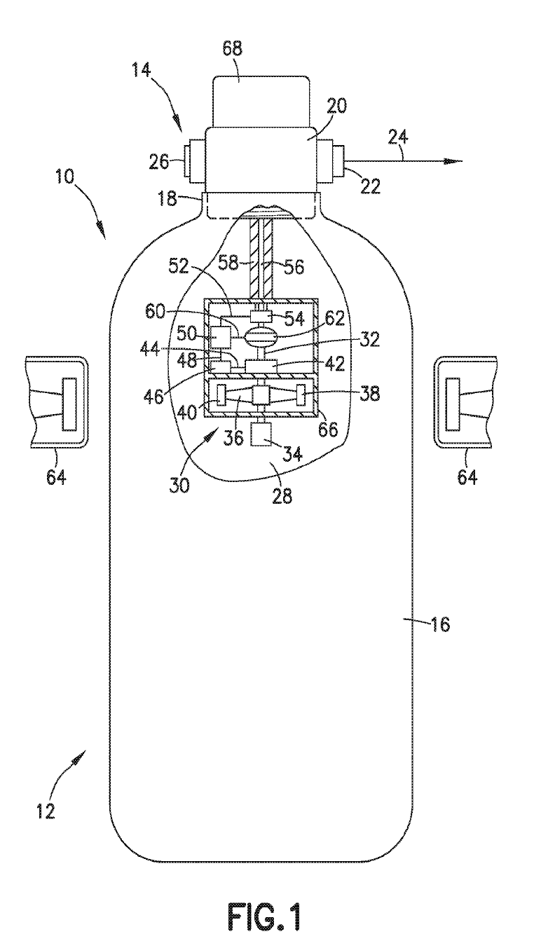

Referring now to the drawings, FIG. 1 is a schematic representation of a fluid supply package 10 according to one aspect of the present disclosure. The fluid supply package 10 includes a fluid supply vessel 12 to which is coupled a valve head 14 at a neck 18 of the vessel, e.g., by complimentary threading on a lower external surface of the valve head and the inner surface of the vessel neck 18. The vessel 12 includes a vessel casing 16 defining an enclosed interior volume 28 of the vessel. In the interior volume 28 is disposed a dispensing control assembly 30. The valve head 14 includes a valve head body 20 with a fluid discharge port 22 to which a fluid discharge line 24, schematically shown in FIG. 1, may be coupled to convey dispensed fluid to a downstream fluid-utilizing apparatus or process system. The valve head body 20 also includes a fill port 26, by means of which fluid may be charged to the fluid supply package in the first instance.

The dispensing control assembly 30 includes a fluid dispensing conduit 32 extending from a lower end coupled with fluid filter 34 to an upper end coupled to fluid discharge tube 58. The fluid filter 34 may comprise a sintered matrix element having porosity that is effective to exclude particulates that might otherwise be entrained in the dispensed fluid and that may be deleterious to the usage of the dispensed fluid.

The components of the dispensing control assembly 30 in the illustrated embodiment are enclosed in a dispensing control assembly housing 66, which together with the fluid discharge tube 58 coupled thereto forms a rigid structure in the interior volume 28 of the vessel 12. Within such housing 66, the internal magnetic drive 36, comprising internal drive magnets 38 and 40, is mounted on the fluid dispensing conduit for rotation, e.g., by a roller bearing sleeve. The internal magnetic drive 36 magnets 38 and 40 are responsive to the rotation of an external magnetic drive 64 that circumscribes the outer surface of the vessel casing 16 and is in spaced relationship thereto. Up on rotation of the external magnetic drive 64, the internal magnetic drive 36 is caused to synchronously rotate, and such rotation is transmitted to magnetic drive power converter 42.

The magnetic drive power converter 42 converts the rotational energy of the internal magnetic drive to an electrical output that is transmitted in charging wire 44 to the rechargeable battery 46, for charging thereof. The rechargeable battery 46 thereby is maintained in a charged state by recharging it, with the external magnetic drive being coupled with the internal magnetic drive, at suitable periodic intervals. The rechargeable battery 46 in turn provides continuous power via a power supply line 48 to the microprocessor 50. The microprocessor is coupled by valve control signal transmission line 62 the flow control device 62, to accommodate transmission from the microprocessor of control signals via line 62 to the flow control device 62 to modulate its set point, so that fluid of desired pressure and/or volumetric flow rate characteristics is caused to flow in the fluid dispensing conduit 32 to the bore 56 of the fluid discharge tube 58 for dispensing from the vessel at fluid discharge port 22.

The flow control device 62 may be an adjustable set point valve, adjustable set point regulator, or other device, e.g., a series arrangement of pressure regulators. Downstream of such flow control device 62 is a pressure transducer 54 configured to output a pressure sensing signal in pressure transducer signal line 52 to the microprocessor 50, so that the microprocessor responsively modulates the set point or other adjustable feature of the flow control device 62, to achieve pressure control of the dispensed fluid from the flow control device.

The dispensed fluid thus flows from the bulk volume of fluid in the interior volume 28 of the vessel 12, is filtered in filter 34 and flows in fluid dispensing conduit 32 to the central bore 56 of fluid discharge tube 58, from which it passes into the valve head body 20, which may contain a flow control valve therein in a valve cavity of the valve head body, with such cavity communicating with the fluid discharge port 22, so that the valve can be translated between a fully closed and fully open position. For this purpose, a valve actuator 68 is coupled with the valve head 14, to correspondingly control the valve in the valve head. The actuator 68 may be of any suitable type, as for example a pneumatic actuator, a solenoid actuator, or other automatic actuator, or alternatively a manual actuator such as a hand wheel.

In another aspect, the disclosure relates to a fluid supply package that includes a pressure-regulated compartment in fluid communication with an adsorbent-based compartment of a unitary fluid supply vessel that is coupled with a valve head for dispensing of fluid from the adsorbent-based compartment at predetermined pressure, wherein the pressure-regulated compartment includes one or more pressure regulators therein configured so that a regulator thereof is in direct flow communication with the adsorbent-based compartment.

In various embodiments of such fluid supply package, the unitary fluid supply vessel comprises enclosing wall and floor members of each of the compartments thereof, wherein the wall and floor members of the pressure-regulated compartment are of increased thickness in relation to the wall and floor members of the adsorbent-based compartment

Thus, the disclosure provides a fluid supply package that includes a pressure-regulated compartment in fluid communication with an adsorbent-based compartment of a unitary fluid supply vessel that is coupled with a valve head for dispensing of fluid at predetermined pressure.

As indicated, the pressure-regulated compartment in this fluid supply package may include enclosing walls that are substantially thicker than the enclosing walls of the adsorbent-based compartment. The pressure-regulated compartment contains one or more pressure regulators, configured so that the regulator, or in the case of multiple regulators the downstream regulator, is in direct fluid flow communication with the adsorbent-based compartment. In this manner, the direct fluid flow communication enables gas to flow into the adsorbent-based compartment from the pressure-regulated compartment whenever pressure in the adsorbent-based compartment falls below the set point of the communicating regulator. This arrangement has the advantage that the adsorbent-based compartment can be maintained at low pressure ensuring safe operation and minimization of the possibility of gas leakage, and the pressure-regulated compartment maintains the gas in such compartment at high pressure, confined by the pressure regulator(s) therein, so that the gas is dispensed from the high pressure pressure-regulated compartment to the adsorbent-based compartment at low pressure, substantially lower than the bulk gas pressure in the pressure-regulated compartment.

This arrangement has the further advantage that any leakage from the high pressure pressure-regulated compartment into the adsorbent-based compartment is “buffered” by increased sorptive uptake of gas by the adsorbent and the consequent increased pressure of dispensed gas can be readily sensed by pressure monitoring of the dispensed gas from the fluid supply package, so that the overall package has an extremely safe character.

The fluid supply package may comprise a valve head including a discharge port for dispensing the gas from the package as well as a fill port that may be used to charge fluid to the high pressure pressure-regulated compartment. The fill port may be coupled with a remote bulk supply of fluid, arranged to periodically charge the pressure-regulated compartment with fresh fluid. The fluid supply package may be utilized in connection with a monitoring and control assembly, including pressure monitoring of the dispensed gas from the package, with the monitoring and control assembly arranged so that the pressure-regulated compartment is charged with fresh fluid whenever monitored pressure of the dispensed fluid from the package falls to a predetermined lower pressure value. In this manner, by coupling the package with a remote bulk supply, the package can be retained in dispensing operation for greatly extended periods of time.

The fluid supply package in the adsorbent-based compartment may contain any suitable adsorbent having appropriate reversible sorptive affinity for the gas to be stored on and subsequently dispensed from the adsorbent. The adsorbent may for example comprise silica, alumina, aluminosilicates, carbon, etc. Such adsorbent may be in any suitable form that is appropriate to the specific fluid supply application for which the packages employed. Illustrative forms that may be employed in the broad practice of the present disclosure include powders, particulate forms, granules, pellets, monolithic forms, etc. Monolithic forms of the adsorbent may include disk-shaped adsorbent articles that are vertically stackable in face-to-face relationship, to form a vertical stack of such adsorbent articles.

The fluid supply package may be deployed in any suitable fluid-utilizing process system, such as a semiconductor manufacturing facility, or facility for manufacturing solar panels or flat-panel displays, or other fluid-utilizing facility.

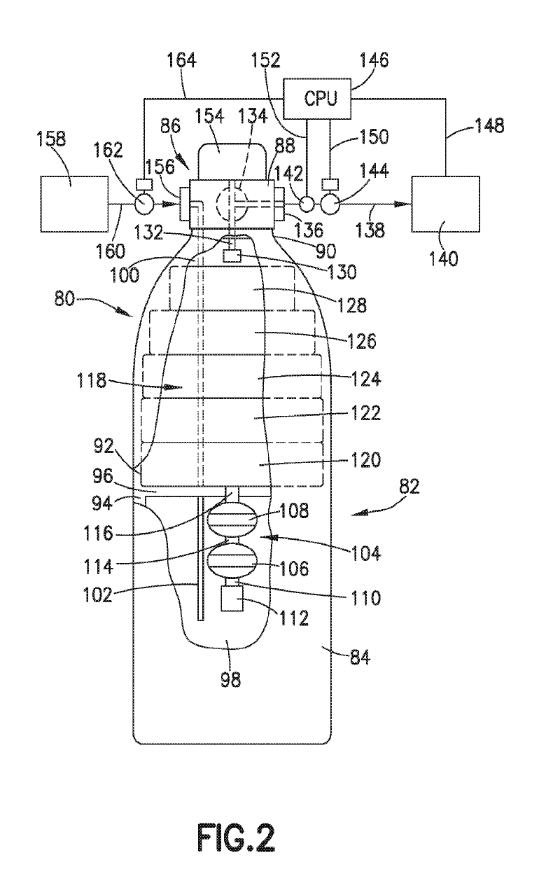

Referring now to the drawings, FIG. 2 is a schematic elevation view of a fluid supply package 80 according to one aspect of the disclosure, wherein the fluid supply vessel 82 is shown in partial breakaway view to illustrate details of the internal construction thereof, and with the fluid supply package being integrated with a fluid monitoring and control assembly.

As illustrated, the fluid supply package 80 includes the fluid supply vessel 82. The vessel includes a vessel casing 84 enclosing an interior volume of the vessel that is divided into respective compartments by the vessel intermediate floor 96. An upper adsorbent-based compartment above vessel intermediate floor 96 includes the upper interior volume 100 in which is disposed adsorbent, described more fully hereinafter. A lower high pressure compartment below the vessel intermediate floor 96 includes lower interior volume 98 in which is disposed a regulator assembly 104. As shown in FIG. 2, the vessel casing lower wall 94 is of substantially increased thickness in relation to the vessel casing upper wall 92, and the vessel intermediate floor 96 is of increased thickness in relation to the vessel casing upper wall, to accommodate the higher pressure fluid that is retained in the lower compartment.

The regulator assembly 104 includes a series arrangement of two pressure regulators, a first regulator 106 and a second regulator 108. In other embodiments, a single regulator can be employed, or more than two regulators can be utilized in series. In the embodiment shown, the first regulator 106 is the upstream regulator that is joined to inlet conduit 110, which in turn is connected to filter 112. The function of the filter 112 is to remove particulates from the high-pressure fluid flowed into the inlet conduit, so that such particulates are not present in the dispensed gas, in which they could adversely affect the downstream manufacturing operation utilizing the dispensed gas.

The first regulator 106 is coupled in series with the second regulator 108 by an intervening intermediate conduit 114, which may be of appropriate length to ensure effective hydrodynamic interaction between the respective pressure regulators in the series arrangement. The first regulator may have a pressure set point of appropriate magnitude, in relation to the pressure set point of the second regulator 108, so that the regulators act to provide pressure-regulated fluid to the discharge conduit 116 which is secured in a corresponding opening in the vessel intermediate floor, for flow of such fluid to the adsorbent-based compartment overlying the vessel intermediate floor.

The fluid supply vessel 82 is coupled at its upper vessel neck 90 with valve head 86 comprising a valve head body 88 which at its lower end may be complementarily threaded for engagement with corresponding threaded interior surface of the vessel neck, to form a leak-tight coupling therebetween. The valve head body 88 has a passage therein communicating with fill port 156 and with the fill tube 102, for introduction of fresh fluid to the pressure-regulated compartment at the open lower end of the fill tube.

The valve head body 88 includes valve 134 in a corresponding valve chamber which communicates with the outlet port 136 of the valve head, and with outlet tube 132 having filter 130 coupled thereto at its lower end, to remove particulates from the gas that is flowed to the outlet port 136 when the valve 134 is open. The valve 134 is coupled with valve actuator 154, which may be of any suitable type, e.g., a pneumatic type, solenoid type, or other automatic actuating type, or alternatively a manual actuating type such as a manual hand wheel actuator.

In the upper adsorbent-based compartment including upper interior volume 100, an adsorbent stacked array 118 is provided, comprising stacked adsorbent articles 120, 122, 124, 126, and 128, with adjacent adsorbent articles in the stack being in face-to-face abutment with one another. Thus, the adsorbent-based compartment receives gas that is flowed through the dispensing fluid path from the lower pressure-regulated compartment, comprising filter 112, inlet conduit 110, first regulator 106, intermediate conduit 114, second regulator 108, and discharge conduit 116. The thus-introduced fluid is adsorbed on the adsorbent of the stacked array 118, from which adsorbate fluid is desorbed and flowed through filter 130, outlet tube 132 and valve chamber of valve 134 to the outlet port 136 under dispensing conditions when the actuator 154 has opened valve 134 to discharge fluid at the outlet port 136 to the discharge line 138.

Fluid thus is stored on the adsorbent in the stacked array 118 at appropriate low pressure, which may be superatmospheric, atmospheric, or subatmospheric in character. In various embodiments, the fluid is stored on the adsorbent at subatmospheric pressure, thereby providing an enhanced measure of safety in respect of any leakage or failure of the valve head or associated components. It will be recognized that the fill tube 102 extends downwardly through the respective adsorbent articles of the stacked array 118, and for such purpose the adsorbent articles 120, 122, 124, 126, and 128 may be formed or otherwise provided, as by drilling, machining, etc., with a passage therethrough to accommodate the downwardly extending fill tube 102.

The fluid supply package 80 may be employed with a bulk fluid supply 158, arranged to provide fluid to the lower pressure-regulated compartment of the package. As illustrated, the bulk fluid supply 158 is arranged to discharge bulk fluid in bulk fluid supply line 160 which is coupled with the fill port 156 of the valve head body 88. The bulk fluid supply 158 may be a remote source of fresh fluid for the fluid supply package 80. The bulk fluid supply line 160 has a fluid supply line flow control valve 162 therein.

The outlet port 136 of the valve head 86 is shown as being coupled to discharge line 138 for flowing dispensed fluid to a fluid-utilizing facility 140, which may be a semiconductor manufacturing facility or other manufacturing facility. The discharge line 138 contains pressure transducer 142 therein, as well has discharge line flow control valve 144.

The fluid supply package 80 shown in FIG. 2 may have a monitoring and control assembly associated therewith, including a central processor unit (CPU) 146 that is operatively linked to various components of the overall system by corresponding signal transmission lines. Thus, the CPU 146 may be operatively linked by a fluid supply line flow control valve signal transmission line 164 to the fluid supply line control valve 162, to modulate such valve between open and closed states thereof. The CPU 146 may also be linked to the fluid-utilizing facility 140 by signal transmission line 148, providing processing signals to the CPU indicative of monitored conditions in the fluid-utilizing facility.

In the FIG. 2 embodiment, the CPU 146 is operatively arranged to receive dispensed fluid pressure signals from a pressure transducer 142 via pressure transducer signal transmission line 152. The CPU 146 also is operatively linked with discharge line flow control valve 144 via flow control valve signal transmission line 150, so that the CPU thereby can modulate discharge line flow control valve 144 in accordance with instructions contained in memory of the CPU, and/or in response to information transmitted to the CPU in signal transmission lines 148 and/or 152.

It will be appreciated that the CPU can be arranged with a wide variety of system monitoring and control components, to provide for dispensing operation of fluid from the fluid supply package. For example, although not shown, the CPU 146 may be operatively linked with valve actuator 154 to correspondingly control valve 134 in the valve head 86 of the fluid supply package.

It will also be appreciated that the respective upper adsorbent-based compartment and lower pressure-regulated compartment arrangement of the fluid supply vessel illustratively shown in FIG. 2 may be varied in other embodiments, and that the pressure-regulated compartment may overlie an underlying adsorbent-based compartment, or the respective compartments may be arranged in side-by-side relationship, or in other confirmations that may be useful and suitable in specific applications.

A further aspect of the disclosure relates to a fluid supply package comprising a fluid supply vessel containing an interiorly disposed fluid dispensing stick assembly including at least one pressure regulator upstream of which is a check valve, wherein the at least one pressure regulator and check valve are configured to enable the fluid dispensing stick assembly to dispense gas from the fluid supply vessel at flow rate in a range of from 2 to 35 standard liters per minute.

In specific embodiments of this fluid supply package, the fluid supply vessel may have a fluid storage volume in a range of from 10 to 60 L. The fluid dispensing stick assembly in various embodiments may include two pressure regulators, upstream of each one of which is a check valve in the fluid dispensing stick assembly. The fluid dispensing stick assembly in various embodiments may be configured to be unitarily removable from the fluid supply vessel.

Accordingly, the fluid supply package in such aspect includes a fluid supply vessel containing an interiorly disposed fluid dispensing assembly, constituted as a “stick” that includes a fluid discharge conduit joined at a lower end to a filter and containing in sequence a first upstream check valve, a first upstream regulator, a second downstream check valve, and a second downstream regulator, with the fluid discharge conduit joined at its upper end to a valve head comprising a valve configured to be adjusted between fully open and fully closed positions and communicating with a discharge port of the valve head. The valve head may be coupled to a valve actuator for such purpose, and may be of automatic or manual character. The fluid dispensing assembly stick may be removed by uncoupling the valve head from the vessel of the fluid supply package.

In lieu of such dual regulator arrangement in which each regulator is preceded by a check valve, the stick assembly can include more than two regulators, each preceded along the flow path of the stick assembly with a corresponding check valve. It also is to be appreciated that the fluid supply package instead of a series arrangement of pressure regulators, upstream of each one of which is disposed a check valve, may include a single regulator with an associated check valve upstream of the regulator in the stick assembly.

Accordingly, the disclosure contemplates a fluid supply package including a fluid supply vessel containing an interiorly disposed fluid dispensing assembly constituted as a stick that includes at minimum at least one pressure regulator upstream of which is a corresponding check valve, to form a sequential check valve/pressure regulator arrangement along the dispensing flow path of the fluid in the fluid dispensing assembly.

The check valve upstream of the pressure regulator may have a suitable crack pressure that is effective to cause the check valve to operate to flow fluid therethrough to the associated pressure regulator, so that the check valve/regulator sub-assemblies of the fluid dispensing assembly operate to provide reduced pressure flow of fluid, and so that the pressure regulators are biased to a closed position under non-dispensing, i.e., fluid storage, conditions. The setpoints of the pressure regulator(s) and cracking pressures of the check valve(s) in the stick assembly are selected to provide suitable pressure and flow rate of the dispensed fluid that is discharged from the vessel under dispensing conditions. The dispensed fluid pressure may thus be controlled by the fluid dispensing assembly, and may be superatmospheric, atmospheric, or subatmospheric in pressure level, and the flow rate may for example be in a range of from 2 to 35 standard liters per minute (slpm) or higher. The vessel may be of any suitable size, and may for example have a fluid storage volume in a range of from 10 to 60 L or more.

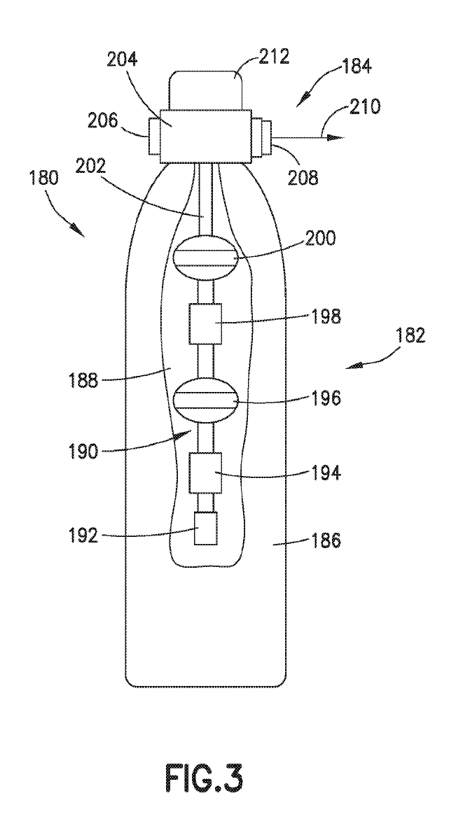

Referring now to the drawings, FIG. 3 is a schematic elevation view of a fluid dispensing package according to another aspect of the disclosure, in which the vessel of the package is shown partially broken away to show the details of the fluid dispensing assembly in the interior volume of the vessel.

In FIG. 3, the fluid supply package 180 is shown as comprising a fluid supply vessel 182 coupled to a valve head 184 at an upper neck portion of the vessel. The fluid supply vessel 182 includes a vessel casing enclosing an interior volume 188 of the vessel. In this interior volume is contained the fluid dispensing assembly 190, as a stick assembly including a fluid discharge conduit 202, which at its lower end is joined to filter 192. The filter 192 is configured with suitable porosity to occlude particulates so that they are not transmitted by the fluid dispensing assembly to the discharge port 208 of the valve head. The fluid discharge conduit at its upper end is secured to the valve head body 204 of the valve head 184, and communicates with a valve chamber in the valve head body that communicates in turn with the discharge port 208. The valve chamber in the valve head body as a valve element disposed therein which is translatable between fully open and fully closed positions, to modulate dispensing of fluid from the fluid supply package.

At its intermediate portion, the fluid discharge conduit 202 is coupled with first check valve 194, first regulator 196, second check valve 198, and second regulator 200, to define a flow path from the bulk volume of the fluid in the interior volume of the vessel through filter 192, check valve 194, regulator 196, check valve 198, and regulator 200 to the valve head 184 for discharge from the discharge port 208 to a suitable dispensed fluid discharge line 210 coupled with the discharge port for dispensing operation, when the fluid supply package is in a dispensing mode with the valve in the valve head in an open position. The valve in the valve head is operatively coupled with a valve actuator 212 that may be of suitable automatic type, e.g., a pneumatic actuator, a solenoid actuator, etc., or alternatively of a manual type, e.g., a manual hand wheel.

The vessel 182 may be charged with fluid for storage, and subsequent dispensing, thereof by fill port 206 of the valve head, which may be coupled with a suitable fresh fluid source, such as a remote bulk source tank coupled with the fill port by suitable flow circuitry.

The fluid supply package of the type shown in FIG. 3 may comprise a valve head 184 in which a lower portion of the valve head body 204 is threaded for complementary engagement with a threaded neck portion of the fluid supply vessel 182. In such manner, the valve head body can be readily uncoupled from the fluid supply vessel, and the fluid dispensing assembly 190 can be removed from the interior volume 188 of the vessel as a unitary structure, for servicing or replacement of its components. The check valve and regulator components of the fluid dispensing assembly can be connected with the respective segments of the fluid discharge conduit 202 by VCR fittings or other suitable coupling elements. The fluid dispensing assembly 190 in other embodiments may be formed so that it is removable as a unitary structure that may for example be otherwise secured in the fluid supply package by a large seal such as a VCR nut with a metal crush seal.

The fluid supply package of FIG. 3 may be used to store, and subsequently dispense, in any suitable fluid for the desired end use application. Such fluid may for example comprise a semiconductor manufacturing fluid, or a fluid useful in manufacture of solar panels or flat-panel displays, as elsewhere described herein in connection with fluid supply packages of other aspects of the disclosure.

A still further aspect of the disclosure relates to a fluid supply package including multiple sub-packages of fluids from which are delivered respective fluids, for mixing in the package and dispensing therefrom of a fluid mixture, wherein the mixing is carried out in a mixing manifold or with a dedicated mixing chamber from which the fluid mixture passes to a dispensing valve of the fluid supply package for dispensing for use.

In such fluid supply package, the sub-packages may be disposed in a casing of the fluid supply package, and the rate of flow of fluids from respective sub-packages in the casing may be controlled by sub-package dispensing lines containing valves controlled by pneumatic valve actuators that are configured to receive fluidic control gas from a source external to the fluid supply package.

In a specific embodiment of such fluid supply package, the package may comprise a first sub-package containing germanium tetrafluoride and a second sub-package containing hydrogen.

The fluid supply package in various embodiments may further comprise flow control devices configured to modulate relative proportions of the fluids provided for the mixing.

Thus, a fluid supply package is contemplated as including multiple sub-packages of fluids from which are delivered respective fluids, for mixing in the package and dispensing therefrom of a fluid mixture. The mixing may be carried out in a mixing manifold or with a dedicated mixing chamber from which the fluid mixture passes to a dispensing valve of the fluid supply package and is dispensed for use.

Any appropriate number of sub-packages may be employed, depending on the number of constituent fluids required in the fluid mixture that is to be dispensed from the package. The respective fluids may be flowed from respective sub-packages within a casing of the fluid supply package, with the rate of flow being controlled by valves in respective sub-package dispensing lines, with such valves in turn being controlled by valve actuators, which may for example comprise pneumatic valve actuators that are configured to receive fluidic control gas from a source external to the fluid supply package.

The fluid supply package comprising multiple fluid supply sub-packages addresses the issues of instability and hazardous character of various gas mixtures, and which therefore are not appropriate for storage in a unitary vessel for significant periods of time. The above-described fluid supply package by the provision of multiple fluid supply sub-packages enables point of use mixing of respective fluids to provide a desired fluid mixture. The sub-packages may comprise separate vessels that are disposed within an outer casing of the fluid supply package, and in which the respective sub-packages are connected together by a manifold communicating with a mixed fluid dispensing line, for subsequent discharge from the fluid supply package. The manifold may simply serve as flow circuitry in which respective fluids encounter and mix with one another in the conduits of such flow circuitry, or the manifold in other embodiments may include a dedicated mixing chamber, in which the respective fluids are mixed to form a mixed fluid that is flowed to the mixed fluid dispensing line, for subsequent discharge from the fluid supply package.

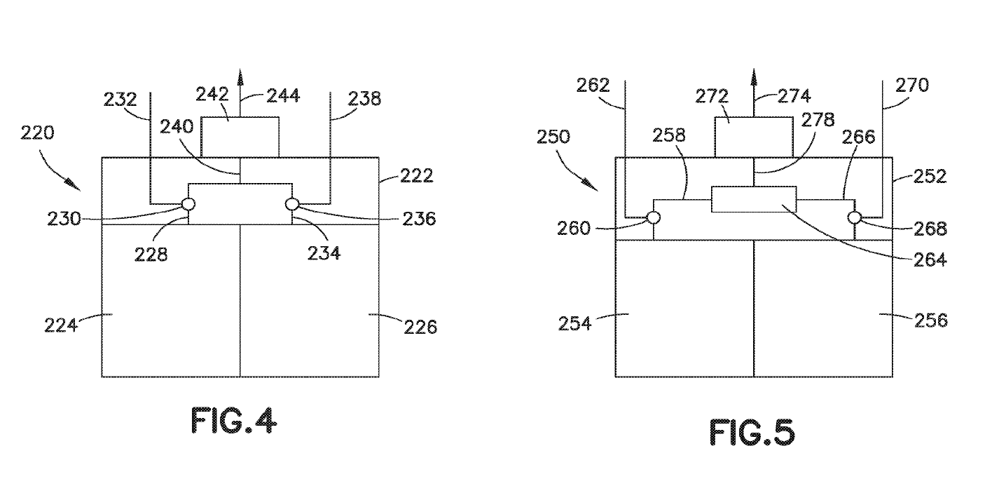

Referring now to the drawings, FIG. 4 is a schematic representation of a fluid supply package 220 including a fluid supply package casing 222 defining an interior volume within the casing in which is disposed a first fluid supply sub-package 224 and a second fluid supply sub-package 226. The first fluid supply sub-package 224 may for example contain germanium tetrafluoride (GeF₄) and the second fluid supply sub-package 226 may contain hydrogen, so that a mixed GeF₄/H₂ fluid can be formed and subsequently dispensed from the fluid supply package.

The first fluid supply sub-package 224 includes a first sub-package dispensing line 228 containing first sub-package dispensing valve 230 therein, wherein the dispensing valve 230 is a pneumatically actuatable valve that may be selectively modulated using air or other gas provided to the first sub-package dispensing valve by the first sub-package dispensing valve pneumatic control line 232. The pneumatic control line 232 may be joined to a suitable source of pressurized gas (not shown).

In like manner, the second fluid supply sub-package 226 includes a second sub-package dispensing line 234 containing second sub-package dispensing valve 236 therein, as a dispensing valve that is pneumatically actuatable and may be pneumatically modulated with air or other control gas provided to the second sub packaging dispensing valve by the second sub-package dispensing valve pneumatic control line 238. The respective dispensing lines 228 and 234 downstream of the respective valves 230 and 236 form a manifold in which the respective first and second fluids from the respective sub-packages are mixed with one another. The resulting fluid mixture then is flowed in mixed fluid manifold line 240 to the fluid supply package dispensing valve 242, which when open under dispensing conditions results in discharge of the mixed fluid to the fluid supply package dispensing line 244.

In order to achieve appropriate relative proportions of the respective first and second fluids in the mixed fluid formed therefrom, the dispensing valves 230 and 236 may be correspondingly set to provide for rates of the respective fluids that combine to provide a desired proportion and concentration of the respective fluids. Alternatively, orifices of different sizes may be employed in the sub-package dispensing lines to achieve such desired relative proportions of the respective fluids in the fluid mixture.

FIG. 5 is a schematic representation of a similar fluid supply package to that of FIG. 4, but wherein a dedicated mixing chamber is provided to effect homogeneity of the blended fluids from the first and second sub-packages.

As shown in FIG. 5, the fluid supply package 250 includes a fluid supply package casing 252 defining an interior volume in which is disposed a first fluid supply sub-package 254 and a second fluid supply sub-package 256.

The first fluid supply sub-package 254 includes a first sub-package dispensing line 258 containing first sub-package dispensing valve 260 therein, wherein the dispensing valve 260 is a pneumatically actuatable valve that may be selectively modulated using air or other gas provided to the first sub-package dispensing valve by the first sub-package dispensing valve pneumatic control line 262. The pneumatic control line 262 may be joined to a suitable source of pressurized gas (not shown).

In like manner, the second fluid supply sub-package 256 includes a second sub-package dispensing line 266 containing second sub-package dispensing valve 268 therein, as a dispensing valve that is pneumatically actuatable and may be pneumatically modulated with air or other control gas provided to the second sub packaging dispensing valve by the second sub-package dispensing valve pneumatic control line 262. The respective dispensing lines 258 and 266 downstream of the respective valves 260 and 268 form a manifold in which is disposed a fluid mixing chamber 264 in which the respective first and second fluids from the respective sub-packages are mixed with one another. The resulting fluid mixture then is flowed in mixed fluid discharge line 278 to the fluid supply package dispensing valve 272, which when open under dispensing conditions results in discharge of the mixed fluid to the fluid supply package dispensing line 274. As described in connection with FIG. 4, the fluid supply sub-package dispensing valves may be preset to provide controlled proportions of the constituent fluids from the sub-packages so that the mixture has a desired composition of the constituent fluids.

The multiple sub-packages of fluids in the embodiments of FIGS. 4 and 5 thereby enable point of use dispensing of constituent fluids for combination to form a mixed fluid stream for dispensing to a fluid-utilizing apparatus or process system. This thereby avoids issues related to storage of a mixture that is subject to degradation or decomposition resulting in toxic, hazardous, or otherwise deleterious species being present in the mixed gas.

It is to be recognized that the respective sub-packages in the fluid dispensing packages of the type illustratively described above in connection with FIGS. 4 and 5 may be of a same or different type, in relation to one another, and may for example include different types of sub-packages selected from among adsorbent-based sub-packages, pressure-regulated sub-packages, solid delivery sublimation sub-packages, and any other sub-packages of other and differing types.

Another aspect of the disclosure relates to a fluid supply package comprising a vessel coupled to a valve head, wherein the vessel contains adsorbent comprising multiple sorbent species, each having selective sorptive affinity for a specific one of respective multiple gas components, so that the respective adsorbent species under dispensing conditions will desorb gas components to form a corresponding gas mixture at a predetermined composition of the respective gas components.

In this fluid supply package, the multiple sorbent species may comprise respective adsorbents having different size pores and pore size distributions. For example, the multiple sorbent species may comprise respective carbon adsorbents of differing character, e.g., in which the differing character comprises difference of at least one of sorbent properties of porosity, pore size distribution, bulk density, sorptive capacity, working capacity, and sorptive selectivity.

Thus, the disclosure provides a fluid supply package including a vessel coupled to a valve head, wherein the vessel contains adsorbent comprising multiple adsorbent species, each having sorptive affinity for a specific one of respective multiple gas components, so that the respective adsorbent species under dispensing conditions will desorb gas components to form a corresponding gas mixture at a desired composition of the respective gas components.

For this purpose, the adsorbent material may be formed with different porosity so that each of the multiple adsorbent materials is “tuned” for a specific gas component of the corresponding mixture. Thus the porosity of a first adsorbent material may have different sized pores and pore size distributions than a second adsorbent material, wherein a first gas component is adsorbed on the first adsorbent material and a second gas component is adsorbed on the second adsorbent material so that when the mixed adsorbents are subjected to the dispensing condition, desorption of the first and second gas components occurs in the desired proportions to yield a gas mixture of desired concentration of the respective components.

The first adsorbent material and second adsorbent material may be of a same material, e.g., both may be carbon adsorbents, but with different porosity, pore size distribution, bulk density, working capacity, sorptive affinity, etc. vis-à-vis the respective gas components to be sorptively retained thereon, so that each gas component has its associated adsorbent storage medium in the mixture of adsorbents. Alternatively, the different adsorbent materials in the adsorbent mixture may be different materials in relation to one another, to provide the adsorbent mixture providing the desired gas mixture for dispensing. By combining the differently tuned adsorbents in a single vessel of a fluid supply package, the different adsorbent materials can be provided in proportion to the desired gas mixture concentration of the respective gas components.

In a given application, the amount of adsorbent needed in the vessel of the fluid supply package would be determined by the working capacity of each adsorbent for its target gas species, divided by the total gas capacity of the adsorbent mixture. Thus, for example, the relative amounts of a first carbon adsorbent having sorptive affinity for phosphine and a second carbon adsorbent having sorptive affinity for hydrogen can be determined from the storage capacity and working capacity of the respective gases, to determine the relative amounts of the first and second carbon adsorbents needed to yield a phosphine/hydrogen gas mixture of specific composition. Accordingly, adsorbent materials may be varied, and/or similar adsorbents may be employed with differing porosity and other physical characteristics to provide for desorption and formation from the desorbed gas is of a gas mixture of the desired composition.

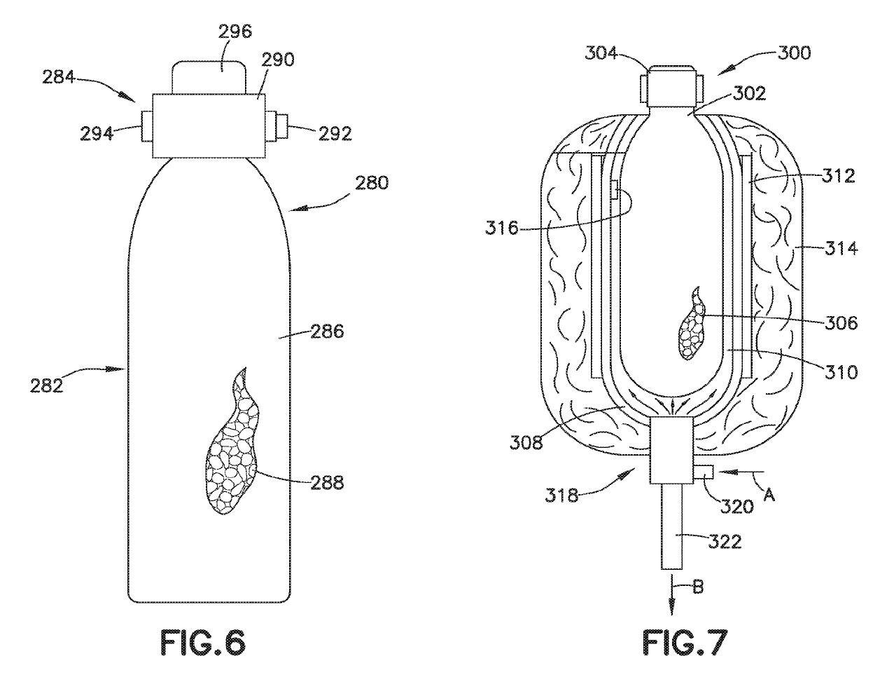

Referring now to the drawings, FIG. 6 is a schematic representation of a fluid supply package 280 comprising a fluid supply vessel 282 leak tightly coupled to a valve head 284. The fluid supply vessel 282 includes a vessel casing 286 defining an enclosed interior volume, in which is disposed an adsorbent mixture 288 comprising different adsorbents each having specific sorptive affinity for a particular component of a desired gas mixture. The respective adsorbent materials may be in any suitable respective forms, including powders, granules, particulates, monolithic forms, etc.

The valve head 284 of the fluid supply package 280 includes a discharge port 292 for discharging gas mixture from the fluid supply vessel under dispensing conditions, and a fill port 294 Ford charging the respective gases to the vessel 282. The valve head 284 contains a valve that may be modulated by the valve actuator 296 associated therewith. The valve actuator may be of any suitable type, including fluidic, electrical, mechanical, and manual forms, with a specific choice of particular actuator being dependent on the specific gas mixture supply operation for which the package 280 is intended.

It will be appreciated that there may not be 100% selectivity of an adsorbent material for a particular gas species of the gas mixture, and that different gas species may be present on a same adsorbent material, but in all instances, each of the respective adsorbent materials in the adsorbent mixture will contribute at least one sorbate gas under dispensing conditions, so that the total desorbate from all adsorbent materials in the vessel forms the gas mixture of desired composition.

In a further aspect, the disclosure relates to a method of packaging a low grade dopant in an adsorbent-based fluid supply package, said method comprising charging the adsorbent with low grade dopant gas so that all or substantially all of the available adsorption capacity of the adsorbent is consumed by the dopant gas in the low grade dopant gas.

In such method of packaging a low grade dopant in a fluid supply package for applications such as the manufacture of solar panels, the term “low grade dopant” refers to a dopant source gas containing less than 99.9% purity of the dopant species, wherein such percentage is weight percent, based on total weight of the dopant source gas.

In various applications, e.g., the manufacture of solar panels, the use of low grade dopants is acceptable. The beam performance of the ion implanter for such dopants will be impacted by the dopant quality to a certain degree, but the extent to which the adsorbent-based fluid supply package is filled is an important consideration that can impact the performance to a great extent. By way of example, if a carbon adsorbent-based fluid supply package is employed for providing phosphine dopant, poor performance is observed for a low grade phosphine dopant that is packaged at lower than available capacity of the carbon adsorbent, when compared to a pure phosphine, i.e., phosphine at greater than 99.99% purity by weight.

Accordingly, by packaging low grade dopant at a lower packing density in the carbon adsorbent matrix, commonly observed and accompanying impurities such as nitrogen will compete for the available core of the adsorbent matrix and have the opportunity to occupy the remaining core matrix that would otherwise available to the desired dopant species. As a consequence, the delivery of the dopant from such fluid supply package will contain impurities at higher levels in proportion to the source gas purity. In other words, the lower the purity of the source gas, the higher the impurity in the delivered dopant gas and the poorer the dopant performance.

By packaging a low grade dopant at the highest possible packing density in the adsorbent matrix, thereby favoring efficient packing of dopant gas first in the available adsorbent core matrix and reducing the opportunity for impurities to adsorb in the core space, lower levels of impurity will be present in the delivered gas when the lower purity source gas is filled to full available capacity of the adsorbent in the fluid supply package, thereby providing improved performance.

Accordingly, the disclosure contemplates a method of packaging a low grade dopant, wherein the adsorbent is charged with the low grade dopant gas so that all or substantially all of the available adsorption capacity of the adsorbent achieved with dopant sorbate gas. As used in such context, the term “substantially all” means at least 95% of the available adsorption capacity of the adsorbent. The available adsorption capacity of the adsorbent may correspondingly be determined from the adsorption capacity of the adsorbent for corresponding high purity (greater than 99.99% purity) sorbate gas at maximum adsorbent loading.

The disclosure in another aspect relates to a thermal management assembly arranged to increase fluid inventory and supplied fluid from an adsorbent-based fluid supply package, the thermal management assembly including a thermal management housing defining a cavity in which the adsorbent-based fluid supply package is disposed during charging of fluid to a fluid supply vessel of the fluid supply package, wherein the fluid supply vessel contains adsorbent having sorptive affinity for the charged fluid, the thermal management housing being configured to provide a convective flow gap between an inner surface of the housing and an outer surface of the fluid supply vessel of the fluid supply package when the fluid supply package is mounted in the cavity, with a heating jacket mounted on the thermal management housing, and the heating jacket surrounded by an insulation jacket, with a vortex cooler coupled with the convective flow gap to generate cold gas for flow through the convective flow gap for cooling of the fluid supply package and the adsorbent in the fluid supply vessel thereof, so that an increased volume of fluid can be charged to the vessel adsorbed on the adsorbent therein, in relation to a corresponding vessel at ambient temperature, and wherein the thermal management assembly is configured for heating of the vessel and adsorbent therein by actuating of the heating jacket and/or flow of hot gas from the vortex cooler through the convective flow gap when the fluid supply package during dispensing operation dispenses gas at a predetermined dispensing condition indicative of exhaustion of fluid inventory, whereby heating of the vessel and adsorbent therein enables the dispensing from the vessel of at least part of residual fluid of the fluid inventory.

Such thermal management assembly may be employed to increase fluid inventory and supplied fluid from an adsorbent-based fluid supply package.

The thermal management assembly includes a thermal management housing in which the adsorbent-based fluid supply package is disposed during charging of fluid to the vessel of the supply package. The approach of this aspect of the disclosure is well-suited to increase fluid capacity of adsorbent-based fluid supply packages that are configured to supply gas at subatmospheric pressure, e.g., for doping operations conducted under subatmospheric pressure conditions. The housing includes a heating jacket mounted on the thermal management housing, with the heating jacket and housing being surrounded by an insulation jacket, to maximize the thermal efficiency of the thermal management assembly.

The fluid supply package is mounted in a cavity defined by the thermal management housing, with a convective flow gap between the inner surface of the housing and the outer surface of the fluid supply vessel of the fluid supply package. A vortex cooler is coupled with the convective flow gap and arranged to supply cold gas thereto during operation of the vortex cooler. The vortex cooler is arranged to receive clean dry air and to generate the cold gas, as well has a hot gas exhaust. The cold gas is flowed over the surface of the fluid supply vessel, to correspondingly chill the vessel and adsorbent contained therein, to sufficiently low temperature so that an increased volume of gas can be charged to the vessel and adsorbed on the adsorbent therein, in relation to a corresponding vessel at ambient (room) temperature.

By such arrangement, the fluid supply package is charged with sufficient gas to increase the inventory in the fluid supply vessel of such package, while at the same time maintaining pressure at or near subatmospheric pressure level. The thermal management assembly may thereafter be maintained in installed condition in relation to the fluid supply package, and subsequently, in the course of dispensing operation when the supply rate of gas from the package begins to decline to a predetermined level, e.g., as evidenced by a pressure monitoring of the dispensed gas, the vessel may be warmed by the heating jacket of the thermal management assembly, optionally as augmented by operation of the vortex cooler so that the hot gas exhaust of such cooler is flowed through the convective flow gap instead of cold gas. Such switching of the supplied fluid from the vortex cooler, from cold gas to hot gas being supplied to the convective flow gap, may be effected by suitable valving and flow circuitry associated with the vortex cooler and the thermal management assembly.

Referring now to the drawings, FIG. 7 is an elevation view showing a fluid supply package 300 mounted in a thermal management assembly, and arranged to substantially increase the fluid capacity of the fluid supply package.

The fluid supply package 300 includes a fluid supply vessel 302 coupled with a valve head 304. The vessel 302 contains adsorbent 306, which may be of any suitable form, and may for example include powder, granules, pellets, or monolithic forms of the adsorbent, such as a carbon adsorbent. The thermal management assembly includes thermal management housing 308, in which the fluid supply vessel is mounted so as to provide a convective flow gap 310 between the outer surface of the fluid supply vessel and the housing 308, through which a heat transfer medium can be flowed to selectively heat or cool the vessel and its contents.

The fluid supply vessel 302 is leak tightly joined to the valve head. The valve head includes a fluid charging port and a fluid dispensing port. Although not shown for clarity, the valve head is suitably coupled by appropriate flow circuitry to a source of fluid to be charged to the vessel 302 for adsorption on the adsorbent 306 in the vessel. The thermal management housing 308 is disposed in a heating element 312 which may be a jacket circumscribing the housing and operable when energized to transmit heat through the housing 308 and gas flow through the convective flow gap for heating thereof so that the vessel is warmed in subsequent dispensing operation.

Surrounding the heating element and the lower portion of the housing is a jacket of thermal insulation 314. The thermal insulation jacket may be formed with a removable upper portion, to accommodate insertion and removal of the fluid supply package 300 from the thermal management assembly. The vortex cooler 318 is arranged to discharge cold air into the convective flow gap, as indicated by the directional arrows in the lower portion of the convective flow gap cavity. The vortex cooler receives clean dry air in clean dryer inlet 320 flowing in the direction indicated by arrow A, and generating a hot gas exhaust that is discharged from the vortex cooler in hot air outlet 322, flowing in the direction indicated by arrow B.

Although the vortex cooler is shown as arranged for cooling of the fluid supply package, such cooler may be arranged with suitable valve or closure members to shut off the flow of cold gas and to redirect the hot air exhaust from outlet 322 to the convective flow gap 310 during the subsequent warming operation, to augment the heating capability conferred by the heating element 312.

During the fluid charging operation, fluid may be introduced into the vessel for adsorption on the adsorbent 306 with the vessel at ambient temperature, following which the vortex cooler 318 may be actuated to initiate cooling and reduce temperature of the fluid supply vessel and adsorbent therein to low temperature, as for example on the order of 0° C., after which further charging of the vessel may take place, since the reduce temperature of the adsorbent enables it to take up additional charged with fluid, introduced into the interior volume of the fluid supply vessel via the fill port in the valve head of the fluid supply package. The fluid supply package thereafter may be maintained at the lower temperature, with continued operation of the vortex cooler to effect such maintenance of the temperature.

Alternatively, the valve head may be closed to charging, and the vessel thereafter allowed to warm to ambient temperature for storage, transport, and/or installation of the fluid supply package at the site of use. Such warming will of course increase the internal pressure in the interior volume of the fluid supply vessel 302, since the adsorbent capacity is reduced with increasing temperature. Nonetheless, the vessel can be sustained at low superatmospheric pressure until it is placed in use, and the fluid supply package is installed to supply gas to a gas-utilizing tool or process system.

Upon such installation, the vortex cooler may again be actuated to chill the vessel and reduce pressure of the dispensed gas to a desired subatmospheric pressure level. Thereafter, gas may be dispensed from the fluid supply package at desired pressure, such as by provision of pressure regulator components in flow circuitry utilized to convey dispensed fluid from the fluid supply package to the downstream tool or use location.

After sustained operation, the fluid in the vessel may approach a heels condition at which the remaining inventory of fluid adsorbed on the adsorbent in the fluid supply vessel is unable to be dispensed. At such point, the vessel may be warmed by actuation of the heating element 312 and/or by redirected flow of hot gas from the vortex cooler through the convective flow gap 310, so that the warming of the vessel and adsorbent therein causes the heels component of the adsorbed gas to thermally desorb so that it can be dispensed from the fluid supply package in continued dispensing operation.

In an alternative mode of operation, the thermal management assembly may be operated so that subsequent to installation, the fluid supply vessel of the package is continuously incrementally warmed to effect dispensing of a full inventory of gas from the vessel. For such purpose, the heating and cooling components of the thermal management assembly may be operatively linked to a central processor unit, so that the respective heating and cooling operations are conducted according to a predetermined cycle time program, or in other manner effecting enhancement of the fluid charging and subsequent fluid dispensing operations.

For such purpose, a temperature sensor 316 may be provided on an interior wall surface of the thermal management housing 308, or such sensor may be attached directly to the wall of the fluid supply vessel, so that the temperature of the vessel is utilized for feedback purposes, to carry out the respective cooling and heating operations for maximization of fluid charging and dispensing from the fluid supply package.

A thermal management assembly of the type shown in FIG. 7 was modeled to determine the enhancement achievable, when charging and subsequently dispensing arsine (AsH₃). The fluid supply vessel in such test contains carbon adsorbent. Charging of arsine to the fluid supply vessel when increased from the normal ambient temperature fill level of 0.48 g of arsine per gram of carbon adsorbent, to 0.52 g arsine per gram of carbon adsorbent, causes the resulting pressure of the filled vessel to be on the order of 1500 torr. Subsequent reduction of the temperature of the fluid supply vessel and adsorbent to 0° C. then causes the pressure of the gas in the fluid supply vessel to be subatmospheric, as free gas in the vessel is adsorbed under lower temperature conditions. Subsequently, in dispensing use, raising temperature of the vessel and sorbent would release an additional 0.1 g arsine per gram of carbon. Accordingly, the two temperature swings, a first cooling swing to increase charged fluid inventory, and a subsequent warming swing to release additional inventory of gas from the vessel, enables the yield of dispensed gas to be increased by 50% (0.42 g arsine per gram of carbon, versus 0.28 g arsine per gram of carbon when such thermal management temperature swings are not employed.

Thus, the thermal management assembly and associated method of thermal management can be effected in a simple and efficient manner, by placement of the fluid supply package in the thermal management assembly, monitoring of wall temperature of the vessel by the temperature sensor, cooling the vessel for enhanced inventory charging of fluid by cold air from a vortex cooler, and subsequently heating the vessel by a heater or hot air from the vortex cooler. The thermal management system may utilize a control system that reads the temperature sensor and controls temperature of the fluid supply vessel, and such control system may receive input from a downstream gas-utilizing tool such as an ion implanter to which gas is flowed from the fluid supply package, with such input being utilized to switch the thermal management assembly from a cooling mode to a heating mode to maximize the volume of dispensed gas that is supplied by the fluid supply package.

A further aspect of the disclosure relates to an adsorbent-based fluid supply package for subatmospheric pressure dispensing of gas, comprising a fluid supply vessel that is coupled with a valve head including a discharge port for dispensing gas from the vessel, wherein the fluid supply vessel contains an adsorbent in an interior volume of the vessel, the adsorbent having sorptive affinity for gas that is adsorbed on and subsequently desorbed from the adsorbent for the dispensing of the gas from the vessel, the package further comprising a backflow and overpressure leakage protection assembly, comprising at least one of (i) a regulator or check valve in the interior volume of the vessel through which gas flows for dispensing from the vessel, and (ii) a regulator or check valve coupled to the discharge port of the valve head for flow of dispensed gas from the discharge port therethrough, wherein the regulators and check valves are configured to prevent back flow into the vessel and overpressure leakage of gas from the vessel.

The disclosure in this aspect thus provides an adsorbent-based fluid supply package for subatmospheric pressure dispensing of gas, in which the fluid supply package is provided with backflow and overpressure leakage protection features. The fluid supply package includes a vessel that is coupled with a valve head. The vessel contains adsorbent as a reversible storage medium for gas that is adsorbed on and subsequently desorbed from the adsorbent for dispensing of the gas from the vessel.

The fluid supply package includes a gas dispensing assembly including the valve head having a selectively actuatable valve therein in a valve chamber arranged for communication with a fluid dispensing conduit in the vessel and a fluid discharge port of the valve head, when the valve of the valve head is in an open position. The fluid dispensing conduit in the vessel contains a flow control device therein, which may comprise a regulator or check valve device. The fluid dispensing conduit may be coupled at its lower end let and with a particulate filter serving to prevent particulates from being entrained in the dispensed gas and carried with the dispensed gas to a downstream point of utilization.

As an alternative to placement of a flow control device in the fluid dispensing conduit in the vessel, a flow control device may be positioned at the discharge port of the valve head, with the flow control device being connected to a coupling for securing the fluid supply package to dispensed gas flow circuitry for delivery of the gas to the downstream point of utilization. The flow control device may comprise a regulator or check valve device.

By the foregoing alternative structures, backflow and overpressure leakage protection are provided in the fluid supply package. When a regulator is used as the flow control device, the regulator is advantageously configured with a subatmospheric pressure set point and is positioned inside or just outside of the fluid supply package. During filling of the vessel of the fluid supply package, the fluid is charged and the vessel is fluid to a predetermined pressure, which may for example be a subatmospheric pressure such as 650 torr. The regulator in such position renders it impossible to backfill the fluid supply vessel to a pressure higher than the regulator setpoint, and eliminates the potential for backfilling with a high pressure gas.

Although 650 torr has been identified as an illustrative set point pressure, the regulator could be set to any suitable subatmospheric pressure, i.e., below 760 torr, but it may be preferable in various implementations of the fluid supply package to provide a regulator having a set point of less than 10-20 torr, which is a typical pressure range to which subatmospheric pressure fluid dispensing vessels are drawn down in dispensing operation.

The foregoing regulator arrangement also eliminates the potential for one fluid supply package to contaminate the and other such package. The regulator also has the advantage that it eliminates the potential for an undesired release of gas from the fluid supply package in the event that the temperature of the package is increased such that the internal pressure is greater than 760 torr, since the regulator will remain closed and protectively contain the gas in the vessel.

As an alternative to utilizing a regulator as such flow control device, a simple check valve, preferably with a low differential pressure rating, may be employed so that the amount of gas that can be withdrawn from the fluid supply package in dispensing operation is not constrained. The check valve could be located either inside the fluid supply vessel, or outside of the fluid supply vessel, at the discharge port of the fluid supply package. The check valve in such positions has the effect of eliminating the potential for backfilling the fluid supply vessel, and can provide a buffer against a release of gas in the event that the fluid supply package becomes heated, although it will be recognize that there will be a corresponding trade-off with the heel component of the gas in the fluid supply vessel.

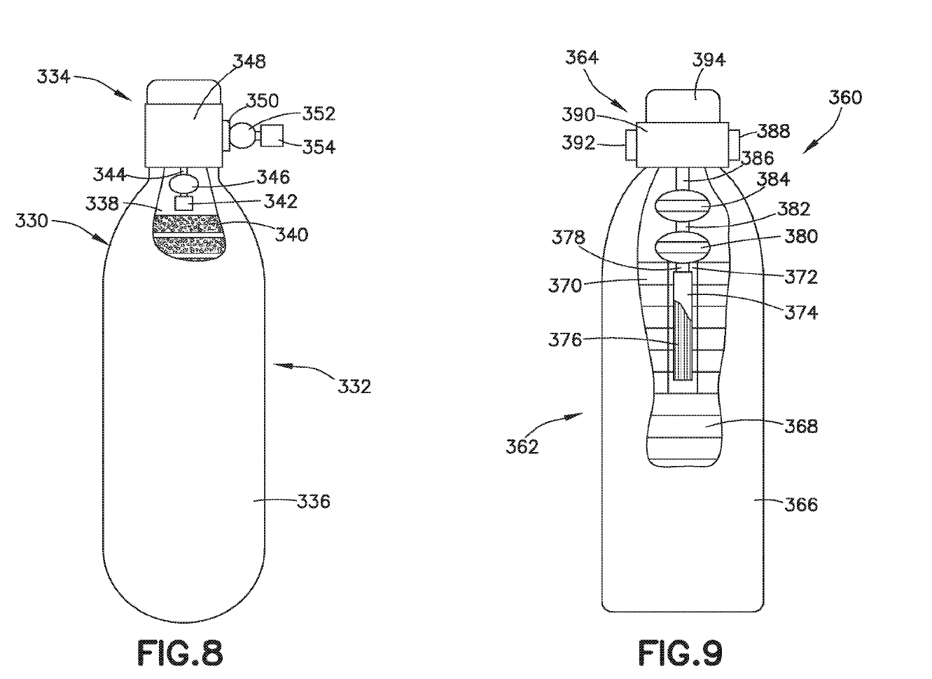

Referring now to the drawings, FIG. 8 is a schematic representation of a fluid supply package equipped with the backfill protection and leak protection features described above.

The fluid supply package 330 includes a fluid supply vessel 330 to which is leak tightly coupled to a valve head 334. The fluid supply vessel includes a vessel casing 336 enclosing an interior volume 338 in which is disposed adsorbent, e.g., in the form of a stack 340 of disk-shaped adsorbent articles.

The vessel includes a fluid dispensing assembly, including the valve head body 348 of the valve head, and fluid dispensing conduit 344 communicating with the valve in the valve head and the discharge port 350 of the fluid supply package, so that fluid is dispensed along a flow path that includes passage through a filter 342 joined to a lower end of the fluid dispensing conduit 344, flow through the flow control device 346, passage in fluid dispensing conduit 344 to the valve in the valve head body 348 and flow when the valve head valve element is open to the discharge port 350 of the fluid supply package. As an alternative to the flow control device 346 in the interior volume 338 of the vessel 332, a flow control device 352 may be provided at the discharge port 350 of the package, with the flow control device being coupled to a discharge port coupling that in turn can be secured to flow circuitry for delivery of dispensed fluid from the fluid supply package to a downstream point of use.

As discussed hereinabove, the flow control device 346 or the alternatively deployed flow control device 352, may comprise a regulator or check valve having fluid flow control characteristics, i.e., a set point pressure setting in the case of a regulator, and a differential pressure flow characteristic in the case of a check valve, which is appropriate to prevent backfilling of gas into the interior volume 338 of the vessel 332 through the gas dispensing flow path, and is effective to prevent overpressure leakage in the event of warming of the vessel leading to an increase of internal pressure in the vessel to super atmospheric pressure levels.

In lieu of the stack of disk-shaped adsorbent articles illustratively described in connection with FIG. 8, the adsorbent in the vessel 332 may be in other appropriate form, such as powder, particles, granules, or the like, or alternatively the adsorbent may be in the form of a single monolithic body that is of a form and volume accommodating its placement in the interior volume 338 of the vessel 332.

The disclosure relates in one aspect to a fluid supply package comprising a fluid supply vessel coupled to a valve head including a discharge port configured for dispensing gas from the package, in which the fluid supply vessel includes in an interior volume thereof a fluid dispensing assembly comprising one or more pressure regulator device(s), in a series arrangement when more than one such device is present, and a capillary tube assembly upstream of the pressure regulator device(s) comprising capillary tubes through which gas is flowed to the pressure regulator device(s), so that gas flows from the pressure regulator device(s) to the valve head for dispensing at a discharge port thereof, and wherein the interior volume of the fluid supply vessel also contains adsorbent as a storage medium for the gas, on which the gas is stored and from which gas is desorbed under dispensing conditions.

The pressure regulator device(s) in such fluid supply vessel may be of any appropriate type, and may for example comprise set point pressure regulator device(s), vacuum-actuated (pressure actuated) check valve(s), or other pressure regulator device(s).

The capillary tube assembly comprises a bundle of parallel capillary tubes arranged so that gas flows from the interior volume through the capillary tubes in parallel to the pressure regulator device(s) in the dispensing gas flow path.

Adsorbent may be provided in the interior volume of the vessel in any suitable form, and may for example comprise a vertical stack of disk-shaped adsorbent articles in which adjacent discs abut each other in face-to-face contact in the stack. The stack may comprise an upper portion in which the discs have a bore therein to accommodate elements of the fluid dispensing assembly extending therethrough. Alternatively, the adsorbent may comprise powder, granules, pellets, or the like in the vessel, with the adsorbent placed to accommodate presence of the fluid dispensing assembly in the interior volume of the fluid supply vessel. The adsorbent itself may be of any suitable type, and may comprise carbon, zeolite, silica, alumina, or other suitable adsorbent material.

This arrangement of a fluid supply vessel containing adsorbent and a fluid dispensing assembly comprising a capillary tube assembly and pressure regulator(s), enables a significantly greater quantity of gas to be stored in the fluid supply vessel at a given pressure, and/or an equivalent amount of gas to be stored at a much lower pressure, as compared with a fluid supply vessel lacking such adsorbent, or a fluid supply vessel lacking such fluid dispensing assembly. The capillary tube assembly has the effect of limiting the steady state flow of gas dispensed from the fluid supply vessel to a relatively low predetermined value, while the regulator(s) or pressure actuated check valve(s) will regulate the delivery pressure of the dispensed gas to a predetermined value, which may be subatmospheric pressure, atmospheric pressure, or superatmospheric pressure, as may be appropriate to a given application of the fluid supply package.

The benefits of the configuration of such fluid supply package include (i) reduction in the number of fluid supply package changeouts that are required in a fluid supply operation, as a consequence of the increased inventory of gas that is accommodated by the fluid supply package, (ii) reduction in the overall requirement of fluid supply packages for a fluid-utilizing facility, due to the increased amount of gas that is available from each fluid supply package, (iii) increased safety and reliability, and reduced mechanical failures, due to reduction in stored gas pressure as a result of use of adsorbent as a gas storage medium in the fluid supply vessel, and (iv) potentially less costly fluid supply package components, due to such reduction in stored gas pressure as a result of use of adsorbent as the gas storage medium.

In specific embodiments, the fluid supply package according to this aspect of the disclosure may comprise a capillary assembly in combination with one regulator, or a capillary assembly in combination with two regulators in series, or a capillary assembly in combination with more than two regulators in series. In the instances in which a series arrangement of two regulators is employed downstream of the capillary assembly, a second regulator accommodates applications in which gas must be delivered from the fluid supply package at subatmospheric pressure, and the pressure in the fluid supply vessel is too high for efficient use of a single pressure regulator as a result of the change of pressure involved. For example, a fluid supply package may be provided in which gas is stored in the fluid supply vessel at pressure of 1000 psig, and a first upstream regulator reduces pressure of the dispensed gas from such 1000 psig pressure to 10 psig pressure, and a second downstream regulator further reduces pressure of the dispensed gas from such 10 psig pressure level to a subatmospheric delivery pressure, e.g., a pressure in a range of 450-500 torr.

Referring now to the drawings, FIG. 9 is an elevation view of a fluid supply package comprising a fluid supply vessel containing adsorbent and a gas dispensing assembly comprising a capillary tube assembly and pressure control device(s).

The fluid supply package 360 shown in FIG. 9 includes a fluid supply vessel 362 leak tightly joined to a valve head 364. The fluid supply vessel 362 includes a vessel casing 366 defining an enclosed interior volume in which is disposed a vertical stack 368 of disk-shaped adsorbent articles, wherein upper disk-shaped adsorbent articles 370 in the stack are formed with a central bore 372 to accommodate a downwardly depending portion of the fluid dispensing assembly.

The fluid dispensing assembly comprises a capillary tube assembly 374 comprising multiple capillary tubes 376 bundled with the individual tubes presenting parallel flow paths for passage of gas into the assembly at the lower open ends of the constituent capillary tubes, so that gas being dispensed flows through such capillary tubes to the inlet dispensing conduit 378, and then pass from such inlet dispensing conduit successively through the first regulator 380, intermediate dispensing conduit 382, second regulator 384, and upper dispensing conduit 386 to the valve head body 390 of valve head 364, from which gas is dispensed from the vessel at the discharge port 388 of the valve head, when a valve in the valve head is in open dispensing position. The valve in the valve head, not shown in FIG. 9, is controlled by the valve actuator 394 operatively coupled with the valve head. The valve head also features a fill port 392, for charging of fluid to the vessel in the first instance.

The fluid dispensing assembly comprising the capillary tube assembly, inlet dispensing conduit, first regulator, intermediate dispensing conduit, second regulator, and upper dispensing conduit thus forms a dispensing gas flow stick defining a dispensing gas flow path, as a unitary structure that may be removed from the vessel with the valve head, when the valve head is uncoupled from the fluid supply vessel. For such purpose, the lower portion of the valve head may be threaded complementarily to threading on an upper neck portion of the fluid supply vessel.

Although illustratively shown as a series arrangement of regulators 380 and 384, it is to be appreciated that in some instances a single regulator may be employed. In other instances, a pressure actuated check valve or assembly of such pressure-activated check valves may be employed. In a specific embodiment, a single vacuum actuated check valve is employed, downstream of the capillary tube assembly. It will be recognize that variations of the construction of the fluid dispensing assembly are possible in which flow control devices other than pressure regulators or pressure actuated check valves are employed, in combination with the capillary tube assembly.

In a further aspect, the disclosure relates to a leak prevention assembly for use in an adsorbent-based fluid supply package employed to dispense gas, said leak prevention assembly being configured for placement upstream of a dispensing valve of said fluid supply package, and comprising a flow control housing including an inlet and outlet for flow of gas therethrough, with a poppet coupled to a bellows assembly that is pressure-responsive in an overpressure condition to translate the poppet to close the outlet of the flow control housing and prevent overpressure gas from being flowed to the dispensing valve and expelled from the fluid supply package when the dispensing valve is open.

Such leak prevention assembly may be employed with an adsorbent-based fluid supply package that is employed to dispense gas, e.g., with the outlet of the leak prevention assembly in gas flow can medication with the dispensing valve of the fluid supply package. The leak prevention assembly has particular utility in application to adsorbent-based fluid supply packages for dispensing gas at low, e.g., subatmospheric, pressures.

The leak prevention assembly thus is applicable to fluid supply packages comprising a fluid supply vessel containing adsorbent, in which the fluid supply vessel is coupled to a valve head for dispensing fluid from the vessel when a valve element in the valve head is opened. If, however, the fluid supply package has been exposed to elevated temperature, the adsorbent may responsively release sorbate gas which will increase pressure in the interior volume of the fluid supply vessel.

Accordingly, if a vessel is designed for dispensing fluid at subatmospheric pressure dispensing conditions, and the vessel and adsorbent therein are warmed to higher temperature, the consequent desorption of fluid may increase the pressure in the vessel to super atmospheric pressure levels that may result in unwanted and undesirable expelling of fluid from the vessel when the valve in the valve head is opened.

In one aspect, the leak prevention assembly is configured to control such overpressure condition, and is coupled in flow communication with the valve in the valve head, e.g., by securing the leak prevention assembly to a lower portion of the valve head body so that the leak prevention assembly controls gas flow to the valve head. If pressure of gas in the vessel under dispensing conditions does not exceed a predetermined pressure level, then gases allowed by the leak prevention assembly to freely flow to the valve head valve chamber.

The leak prevention assembly includes a flow control housing including an inlet and outlet for flow of gas therethrough, with a poppet coupled to a bellows assembly that is pressure-responsive in an overpressure condition to translate the poppet to close the outlet of the flow control housing and prevent the overpressure gas from being expelled from the fluid supply package.

In another aspect, the leak prevention assembly is configured to prevent flow from the fluid supply package when there is an overpressure condition and temperature of the fluid supply package is high, i.e., the temperature presents an over-temperature condition. Such configuration is useful when both overpressure and over-temperature conditions are required to be present in order for prevention of flow from the fluid supply package to be effected. For such purpose, the leak prevention assembly is configured as described above in connection with the leak prevention assembly for preventing overpressure, but with the further modification that the poppet is coupled with a bellows assembly by a connecting expansible memory material element, e.g., a memory metal spring, which expands when temperature is above a predetermined set point temperature. In this modified configuration, the leak prevention assembly when the pressure is low and the temperature is high (above the temperature setpoint) does not cause the poppet to engage the flow control housing outlet. The same is true, i.e., the leak prevention assembly does not cause the poppet to engage the flow control housing outlet, when the pressure is high and the temperature is low. However, under conditions of overpressure and over-temperature, the expansible memory material element will expand and the bellows assembly with the expanded memory material element will cause the poppet to engage the flow control housing outlet and prevent flow of gas from the fluid supply package.

Thus, the leak prevention assembly is usefully employed to overpressure, or overpressure/over-temperature conditions that may otherwise result in unwanted expulsion of gas from the fluid supply vessel when the valve in the valve head is opened.

Accordingly, the disclosure contemplates a leak prevention assembly for use in an adsorbent-based fluid supply package employed to dispense gas, said leak prevention assembly being configured for placement upstream of a dispensing valve of said fluid supply package to prevent dispensing of gas from the fluid supply package, and comprising a flow control housing including an inlet and outlet for flow of gas therethrough, with a poppet coupled by an expansible memory material device to a bellows assembly that is responsive only when both an overpressure condition and an over-temperature condition exist, to translate the poppet to close the outlet of the flow control housing and prevent gas from being flowed to the dispensing valve and expelled from the fluid supply package when the dispensing valve is open. As indicated above, the expansible memory material device may comprise a memory metal spring or other suitable expansible memory material device.

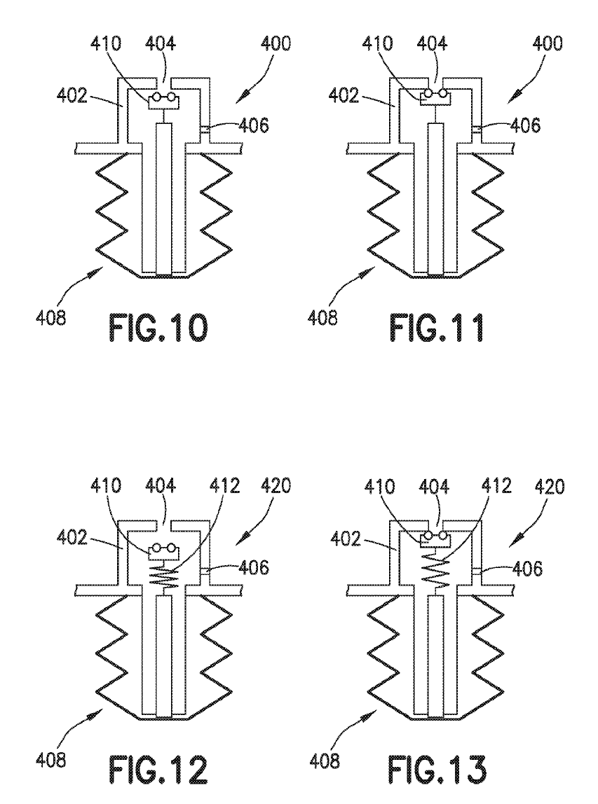

Referring now to the drawings, FIG. 10 is a schematic elevation view of a leak prevention assembly according to one embodiment of the disclosure. As illustrated, the leak prevention assembly 400 includes a flow control housing 400 to having an outlet 404 and inlet 406 for flow of gas therethrough when the poppet element 410, associated with the bellows assembly 408, is not engaged with the flow control housing outlet 404. This leak prevention assembly may be mounted in the interior volume of a fluid supply package such as a package of the type shown in FIG. 6 hereof, so that the flow control housing outlet 404 is in closed flow communication with the valve chamber in the valve head of the package, and with the flow control housing inlet 406 in communication with gas in the interior volume of the fluid supply vessel of such package.

FIG. 11 is a schematic elevation view of the leak prevention assembly of FIG. 10, in which the assembly has responded to an overpressure condition in the fluid supply vessel, and the bellows assembly has responsively translated the poppet so that it closes the flow control housing outlet to gas flow, thereby preventing expulsion of overpressure gas when the valve is opened in the valve head of the fluid supply package in which the leak prevention assembly is installed. All parts and features of the leak prevention assembly in FIG. 11 are numbered consistently with the numbering of the same parts and features shown in FIG. 10.

FIG. 12 is a schematic elevation view of a leak prevention assembly 420, in which all corresponding parts and features are numbered consistently with the numbering of the same parts and features in FIGS. 10 and 11, but with further modification that the leak prevention assembly is configured so that the poppet element 410 is coupled with the bellows assembly by a memory metal spring 412 having a set point temperature at or above which the memory metal spring will expand. The FIG. 12 leak prevention assembly is constructed so that flow gas through the flow control housing from the inlet to the outlet thereof is accommodated when either there is an overpressure condition in the fluid supply vessel, but the temperature is below the set point temperature of the memory metal spring, or there is a temperature above the set point temperature of the memory metal spring, but the pressure in the fluid supply vessel is below the overpressure pressure condition, but when both overpressure and over-temperature conditions are present, the bellows assembly will act with the memory metal spring to translate the poppet element 410 to engage and occlude the flow control housing outlet so that flow is prevented, as shown in FIG. 13, wherein all parts and features are numbered correspondingly to the numbering of the same parts and features in FIG. 12.

It will therefore be appreciated that the leak prevention assemblies of FIGS. 10-13 can be employed to efficiently prevent expulsion of gas on opening of the valve in the valve head of the fluid supply package, in overpressure or overpressure/over-temperature conditions.

In an additional aspect, the disclosure relates to a fluid supply package including a pressure-regulated fluid supply vessel coupled to a valve head for dispensing of gas at a predetermined pressure level, comprising a gas dispensing assembly in an interior volume of the fluid supply vessel, and a pressure monitoring and shutoff assembly coupled with the gas dispensing assembly in the interior volume of the vessel and configured to prevent dispensing in an overpressure condition exceeding a predetermined pressure.

The gas dispensing assembly may comprise a gas stick defining a dispensed gas flow path, and including one or more flow control devices therein, selected from the group consisting of pressure regulators, pressure actuated check valves, capillary assemblies, and particle occlusion devices. The pressure monitoring and shutoff assembly may in specific embodiments comprise a pressure transducer pressure monitoring device. In various embodiments, the pressure monitoring and shutoff assembly may comprise a flow control valve operably coupled to a pressure monitoring device so that the flow control valve is closed in the overpressure condition.

Thus, the disclosure contemplates a fluid supply package including a pressure-regulated fluid supply vessel coupled to a valve head for dispensing of gas at a predetermined pressure level, e.g., a subatmospheric pressure level, comprising a gas dispensing assembly in an interior volume of the fluid supply vessel, and a pressure monitoring and shutoff assembly coupled with the gas dispensing assembly in the interior volume of the vessel to prevent dispensing in an overpressure condition.

The gas dispensing assembly of the interior volume of the vessel comprises a gas stick defining a dispensed gas flow path. The gas stick includes flow control devices, which may comprise pressure regulator(s) and/or pressure actuated valve(s) and particle filters to prevent particulates from being entrained in the dispensed gas from the package.

A pressure monitoring and shutoff assembly is provided between the gas stick and the valve head of the package, wherein the pressure monitoring and shutoff assembly senses pressure of gas transmitted by the gas stick and if such pressure is above a predetermined pressure set point, the pressure monitoring and shutoff assembly thereupon terminates flow from the gas stick to the valve head of the package. If the pressure of gas transmitted by the gas stick is at or below the predetermined pressure set point, the pressure monitoring and shutoff assembly will allow gas to flow from the gas stick to the valve head for dispensing from the package. Accordingly, the pressure monitoring and shutoff assembly may comprise a flow control valve that is operably coupled to a pressure monitoring component such as a pressure transducer in the pressure monitoring and shutoff assembly, whereby a pressure above the set point pressure causes an output signal to be sent by the transducer to the flow control valve to effect its closure and prevention of gas flow to the valve head.

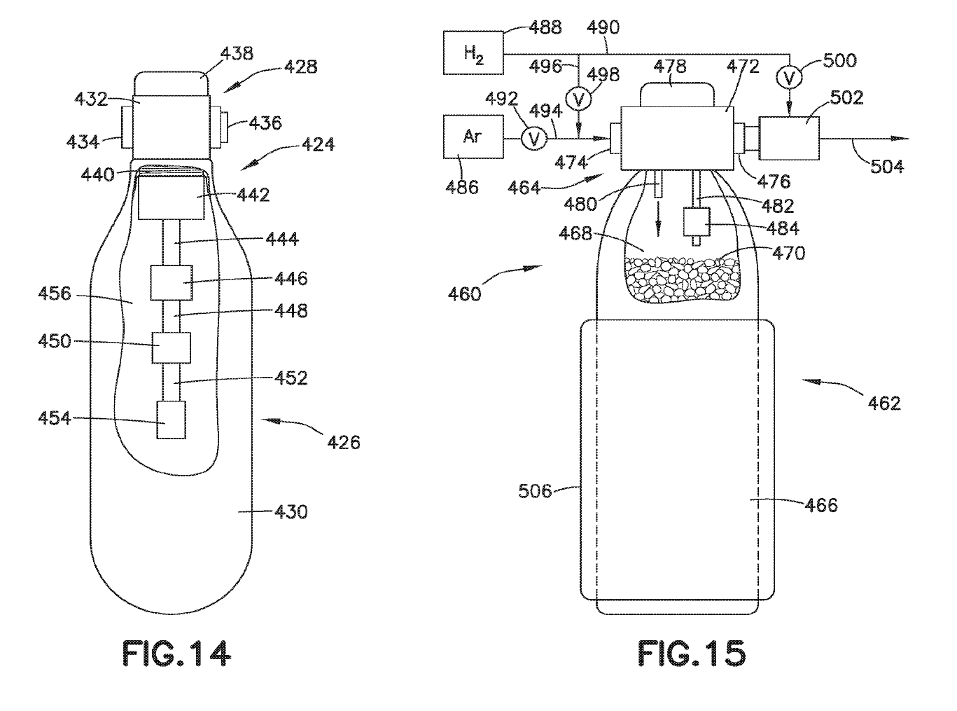

Referring now to the drawings, FIG. 14 is a schematic elevation view of a fluid supply package in which the vessel is shown partially broken away to illustrate the structural details of the gas stick and the pressure monitoring and shutoff assembly.

As illustrated, the fluid supply package 424 comprises a fluid supply vessel 426 defining therein an interior volume 456 for holding gas. The fluid supply vessel 426 includes a vessel casing 430, shown partially broken away, to illustrate the internal structure in the interior volume. The fluid supply vessel 426 is coupled to a valve head 428, by means of threading on a threaded engagement portion 440 of the valve head body 432 of valve head 428. Such threading is complementary to threading on an interior surface of the upper neck portion of the fluid supply vessel 426, so that when the vessel in the valve head are threadably engaged with one another, a leak tight seal is formed.

The valve head 428 is also coupled to a valve actuator 438, which is coupled with a valve (not shown in FIG. 14) in the valve head, to modulate such valve between fully open and fully closed positions. The valve head body 432 includes a fill port 434 for charging fluid to the fluid supply vessel, and a discharge port 436 for dispensing gas from the vessel.

In the interior volume 456 of the fluid supply vessel 426, a gas stick is provided, including upper dispensing conduit 444, pressure regulator or check valve 446, intermediate dispensing conduit 448, pressure regulator or check valve 450, lower dispensing conduit 452, and filter 454. Although two regulator or check valve components are shown arranged in series in the gas stick, other variations are possible in which only one regulator or check valve is comprised in the gas stick, or in which more than two regulators or check valves are employed. The check valves may be of a pressure actuated type, and when multiple regulators or check valves are employed, each may operate so that successive reductions in dispensed gas pressure are achieved in the respective devices so that the gas is reduced in pressure to the desired dispensed gas pressure level. The filter 454 may comprise a sintered metal matrix filter, to prevent particles from being entrained in the dispensed gas, or a capillary tube assembly may be in used in place of, or in addition to, the filter.

The upper dispensing conduit 444 at its upper end is connected to the pressure sensing and shut off valve assembly 442, which in turn is connected to the valve head body 432 at a lower extremity thereof in the interior volume 456 of the fluid supply vessel. As described hereinabove, the pressure sensing and shutoff valve assembly 442 senses the pressure of gas from the gas stick, and if such pressure is above a predetermined set point, indicative of an over pressure condition in the dispensed gas, the pressure sensing and shutoff valve assembly 442 responsively operates to terminate the flow of gas to the valve head. For such purpose, the pressure sensing and shutoff valve assembly 442 may comprise a pressure transducer that is operatively arranged to sense the pressure of gas from the gas stick and to responsively actuate a shutoff valve in the pressure sensing and shutoff valve assembly to prevent overpressure gas from being dispensed from the fluid supply package.

By such arrangement, the sensing and shut off valve assembly operates to ensure that gas dispensed from the fluid supply package is at desired dispensing pressure, and thereby serves to provide an additional measure of safety in the event that one or more components in the gas stick is disabled from performing its normal function.

In yet another aspect, the disclosure relates to a fluid supply package comprising a pressure-regulated fluid supply vessel coupled to a valve head, wherein the pressure regulated fluid supply vessel contains in an interior volume of the vessel a fluid dispensing assembly comprising a series arrangement of pressure regulators, in which the regulators are configured to provide dispensed fluid from the fluid supply package at pressure at or slightly above atmospheric pressure, thereby obviating the need for a vacuum process or pump to boost the dispensed gas pressure and drive the gas flow, and wherein a restrictive flow orifice is optionally provided in a gas flow passage of a valve in the valve head of the fluid supply package.

In such fluid supply package, the series arrangement of pressure regulators may be configured to provide dispensed fluid from the fluid supply package at pressure of 800 to 1000 torr.

The fluid supply package may be coupled to gas flow circuitry for delivery of dispense gas to a gas-utilizing system operating at or slightly above atmospheric pressure, wherein the gas flow circuitry does not contain (i) a pressure booster device for driving the gas flow from the fluid supply package to the gas-utilizing system, or (ii) an external regulator in the gas flow circuitry.

Accordingly, the disclosure provides a fluid supply package comprising a pressure-regulated fluid supply vessel containing in an interior volume of the vessel a fluid dispensing assembly comprising a series arrangement of pressure regulators, in which the regulators are configured to provide dispensed fluid from the fluid supply package at pressure at or slightly above atmospheric pressure, thereby obviating the need for a vacuum process or pump to boost the dispensed gas pressure and drive the gas flow, wherein a restrictive flow orifice may optionally be provided in a throat passage of a valve in the valve head of the fluid supply package. Accordingly, the fluid supply package may be configured as described in connection with FIG. 14 hereof, with or without the pressure sensing and shutoff valve assembly, and wherein the optional restrictive flow orifice may be disposed in an inlet passage of the valve head body 432, in the discharge port 436 of the valve head, or in the upper dispensing conduit 444 of the gas stick in such vessel.

In specific embodiments of this fluid supply package, a first, upstream regulator 450 may drop the dispensed gas pressure from storage pressure to pressure on the order of approximately 100 psia, and the second, downstream regulator 446 may drop the pressure to a usable pressure level slightly above atmospheric pressure, e.g., in a range of 900±100 torr.

Accordingly, the fluid supply package provide sufficient driving force to deliver the gas to a gas-utilizing system operating at or slightly above atmospheric pressure, without the necessity of the system constituting a vacuum process or requiring the use of a pump to boost the pressure and drive the gas flow.

A user can thereby connect the fluid supply package in series to any suitable type of flow control to the downstream gas-utilizing process. No external regulator therefore is required in the dispensed gas delivery flow circuitry. This enables fewer components and connections to be utilized, thereby reducing the potential for an unwanted gas release, particularly if the dispensed gas is of a toxic or otherwise hazardous character. In addition, opening of the valve in the valve head, or failure of a fitting, will not cause a high-pressure ballistic and catastrophic release of gas, but instead a correspondingly more controlled release. As indicated, a restrictive flow orifice (RFL) can optionally be fitted into the valve head valve throat or other suitable flow path location of the dispensed gas, to provide additional safety against accidental release of gas.

A further aspect of the disclosure relates to a fluid supply package of a type selected from the group consisting of adsorbent-based fluid supply packages, pressure-regulated fluid supply packages, and adsorbent-based and concurrently pressure-regulated fluid supply packages, the fluid supply package comprising a fluid supply vessel coupled to a valve head configured for dispensing gas from the fluid supply vessel in dispensing operation of the fluid supply package, and the fluid supply package containing co-packaged implant dopant gases in the fluid supply vessel, wherein the co-packaged implant dopant gases do not include elements in respective gases that will result in cross-contamination in ion implantation operation utilizing gas dispensed from the fluid supply package.

The fluid supply package may be variously configured, and may for example comprise at least one pressure regulator device in a dispensed gas flow path in an interior volume of the fluid supply vessel of the package, e.g., wherein such pressure regulator device is selected from the group consisting of pressure regulators of the poppet valve and bellows-type, and pressure actuated check valves.

In specific embodiments, the co-packaged implant dopant gases comprise a gas mixture selected from the group consisting of: AsH₃/PH₃; AsH₃/SiH₄; PH₃/GeH₄; AsH₃/SiH₄/PH₃; BF₃/GeF₄; SiF₄/GeF₄; SiF₄/BF₃; SiF₄/BF₃/GeF₄; CO₂/AsH₃; CO₂/PH₃; CO₂/BF₃; CO₂/GeF₄; and CO₂/SiF₄.

The fluid supply package may be of any suitable type, and may for example be of a type that is selected from the group consisting of adsorbent-based fluid supply packages, and adsorbent-based and concurrently pressure-regulated fluid supply packages, wherein the adsorbent comprises multiple adsorbent species, each of which is selective for one of the co-packaged implant dopant gases.

Thus, the disclosure provides for co-packaging of mixtures of implant gases in a single adsorbent-based fluid supply package, a single pressure-regulated fluid supply package, or a single adsorbent-based and concurrently pressure-regulated fluid supply package, in which the pressure-regulated fluid supply package comprises a fluid supply vessel in which is disposed at least one pressure regulator device in the dispensed gas flow path in the interior volume of the fluid supply vessel of the package. The pressure regulator device may be of any suitable type and may for example include one or more pressure regulator of the poppet valve and bellows-type and/or one or more pressure actuated check valve. Thus, the fluid supply package may comprise a fluid supply vessel configured as variously described herein.

Since an ion implanter utilizes an analyzing magnet to select an appropriate elemental/molecular ion species for the implantation, it is contemplated to co-package various implant dopant gases in a same fluid supply package, in the fluid supply vessel thereof, subject to the constraint that co-package gases not include elements that may result in cross-contamination in the ion implantation operation, due to fragments or elements of identical or similar atomic mass being present. Illustrative co-packaging mixtures of implant gases include, without limitation, AsH₃/PH₃; AsH₃/SiH₄; PH₃/GeH₄; AsH₃/SiH₄/PH₃; BF₃/GeF₄; SiF₄/GeF₄; SiF₄/BF₃; SiF₄/BF₃/GeF₄; CO₂/AsH₃; CO₂/PH₃; CO₂/BF₃; CO₂/GeF₄; and CO₂/SiF₄.

In such co-packaging fluid supply packages, pressure-regulated fluid supply packages may be employed for delivery of a fluid mixture composition that will not change with time during the dispensing operation. When co-packaging fluid mixtures in adsorbent-based fluid supply vessels, the mixture composition may change with time due to differential adsorption/desorption characteristics of the respective fluid components, and this can be accommodated in implanters having the capability to auto-tune implanter operating characteristics for a variable composition dopant source material in order to achieve a desired beam current in the ion implantation operation. Alternatively, such fluid mixtures can be accommodated by tailoring individual adsorbents in an adsorbent mixture to compensate differential adsorption/desorption characteristics of the respective fluid components, to achieve a consistent gas mixture composition in the dispensed gas during the dispensing operation, as described elsewhere herein.

In another aspect, the disclosure relates to a fluid supply package comprising multiple sub-vessels in a fluid supply package vessel, one of said multiple sub-vessels containing an ion implantation dopant source gas, and another of said multiple sub-vessels containing a cleaning gas, wherein the sub-vessels are each configured to dispense gas independently of the others. The fluid supply package may be variously configured, and may for example comprise a mixing manifold or mixing chamber configured for mixing of the dispensed ion implantation dopant source gas and cleaning gas, and flow of a resulting dopant source gas/cleaning gas mixture to a dispensing valve of the fluid supply package.

Accordingly, the disclosure in such aspect enables co-packaging in a same fluid supply package a dopant source gas and a cleaning gas, wherein the fluid supply package is configured to comprise multiple sub-vessels each containing one of such gases within an overall fluid supply package vessel, as depicted in FIG. 4, but wherein gas from each of the separate multiple sub-vessels is independently dispensable from the others.

Thus, in reference to FIG. 4, the sub-package 224 can comprise a sub-vessel containing a dopant source gas, and the sub-package 226 can comprise a sub-vessel containing a cleaning gas such as xenon difluoride (XeF₂). Since xenon difluoride is a dense solid at room temperature conditions that sublimates to form xenon difluoride vapor, the sub-vessel containing xenon difluoride can be of small-volume, e.g., less than 300 mL, and thus substantially smaller than the sub-package containing the dopant source gas. In a package configuration is shown in FIG. 4, either of the sub-package dispensing valves 230 and 236 may be independently open or closed, so that closure of one of such valves allows the other valve to be open for dispensing of the fluid from the associated sub-vessel, by flow through the dispensing line 228 or 234, and manifold line 240, to the dispensing valve 242, for dispensing in the fluid supply package dispensing line 244. Alternatively, the fluid supply package may comprise a fluid supply vessel including a two-port valve head with the respective ports communicating with different passages in the valve head, as for example is shown in FIG. 2, wherein the respective passages are coupled in the interior volume of the vessel casing with respective sub-vessels, one containing the dopant source gas and the other containing the cleaning gas, wherein each of the gases is apparently dispensable from a respective port of the valve head, using independently actuatable dispensing valves. As a still further alternative, separate dopant source gases may be co-packaged in a same fluid supply package, such as where the respective dopant source gases are not mutually compatible.

The disclosure relates in a further aspect to a fluid supply package including a pressure-regulated fluid supply vessel coupled to a valve head for dispensing of gas at a predetermined pressure level, and comprising a gas dispensing assembly in an interior volume of the fluid supply vessel, the gas dispensing assembly comprising a gas stick defining a gas flow path including at least one flow control device, wherein an upper portion of the gas stick is coaxial with the fluid supply vessel and a lower portion of the gas stick comprises a conduit that is angled away from the coaxial upper portion of the gas stick and is coupled at a lower end thereof to a gas-permeable membrane for occlusion of particles from gas flowed through the gas stick for dispensing from the fluid supply package.

In such package, the flow control device(s) in the gas stick may be selected from the group consisting of pressure regulators and pressure actuated check valves.

In a specific embodiment, the angled lower portion of the gas stick may be angled away from the coaxial upper portion of the gas stick so as to define an included angle between the axis of the coaxial upper portion of the gas stick and the angled lower portion of the gas stick, that is in a range of from 10° to 25°.

In the foregoing aspect, the fluid supply package may include a pressure-regulated fluid supply vessel coupled to a valve head for dispensing of gas at a predetermined pressure level, e.g., a subatmospheric pressure level, utilizing the gas dispensing assembly in an interior volume of the fluid supply vessel.

The gas dispensing assembly of the interior volume of the vessel comprises a gas stick defining a dispensed gas flow path. The gas stick includes flow control devices, which may comprise pressure regulator(s) and/or pressure actuated valve(s) and a dispensed gas inlet conduit through which gas flows to the flow control devices and thereafter to the valve head of the fluid supply package.

In order to avoid pressure drop issues associated with filtering of the gas to remove any particles therefrom so that particles are not entrained in the gas that is dispensed from the fluid supply package, such as is attributable to the use of sintered metal matrix frit elements, the dispensed gas inlet conduit is angled at a minor angle from the vertical axis of the gas stick, and the dispensed gas inlet conduit is coupled at its lower end with a membrane to prevent particulates from entering the gas stick. The membrane may be formed of any suitable material of construction is effective to occlude particles from the dispensed gas that is flowed through the stick. For example, the membrane may be formed of polytetrafluoroethylene or other polymeric or non-polymeric material construction, having appropriate permeability and solid particulate occluding character. The membrane exhibits no capillary action, and provides an effective and reliable barrier structure to enable gas to freely enter the gas stick for dispensing while occluding particles from the dispensed gas.

The dispensed gas inlet conduit's minor angle of orientation is in a range of from 10° to 25°, as measured from the central vertical axis of the gas stick when the vessel is placed in a vertically upstanding position. By offsetting the inlet of the gas stick from the center of the fluid supply vessel to an offset position radially outward from such center position, the gas stick is displaced upwardly from the position that it would occupy if extended downwardly at the center axis of the gas stick, thereby additionally allowing particles to further disengage from the gas before entering the gas stick, in relation to a centrally positioned gas stick inlet in greater proximity to the floor of the vessel where particles may accumulate.

Thus, in relation to the fluid supply package structure shown in FIG. 14, wherein the gas stick includes filter 454, the foregoing configuration of the fluid supply package may be realized by utilization of a polytetrafluoroethylene membrane element in place of filter 454, and with angling of the lower dispensing conduit 452 from the vertical position coaxial with the central axis of the gas stick, to an angled position in which the included angle between the angled lower dispensing conduit and the central vertical axis of the gas stick may be in a range of 10° to 25°, e.g., 15°. Such fluid supply package may be configured with or without the pressure sensing and shut off valve assembly 442 shown in FIG. 14, and may utilize one regulator or check valve component rather than the series arrangement of regulators or check valves that is shown in such drawing.

In yet another aspect, the disclosure relates to a point of use generation system for generating a gaseous reagent, the system comprising a fluid supply package including a fluid supply vessel coupled to a valve head for dispensing of gas, the fluid supply vessel containing a reactant material for the gaseous reagent, the valve head of the fluid supply package being coupled by flow circuitry with (i) a source of carrier gas and/or (ii) a source of co-reactant(s) that are reactive with the reactant material in the fluid supply vessel, and optionally with (iii) an ancillary reaction chamber arranged to receive dispensed gas from the fluid supply vessel and to reactively generate the gaseous reagent, with the point of use generation system being configured for reacting co-reactant(s) with the reactant material either in the fluid supply vessel or in the ancillary reaction chamber.

In one embodiment, the point of use generation system comprises the ancillary reaction chamber, wherein the valve head of the fluid supply package is coupled by flow circuitry with a source of carrier gas to deliver carrier gas to the fluid supply vessel for flow therethrough to entrain vapor of the reactant material so that a carrier gas/reactant material vapor mixture is flowed as the dispensed gas to the ancillary reaction chamber, and wherein a source of co-reactant is coupled by flow circuitry with the ancillary reaction chamber to introduce the co-reactant thereto for reaction of the reactant material and co-reactant to generate the gaseous reagent.

The fluid supply vessel in various embodiments comprises a pressurized regulated fluid supply vessel.

The point of use generation system may further comprise a heater arranged to heat the fluid supply vessel to volatilize the reactant material therein. In a specific implementation, the reactant material may comprise elemental arsenic, and the co-reactant may comprise hydrogen.

Thus, the disclosure provides a fluid supply package that is configured for point of use generation of a gaseous reagent such as a dopant source gas, in which a reactant material is contained in a fluid supply vessel and utilized to carry out a reaction generating the desired gaseous reagent.

The fluid supply package includes a fluid supply vessel in which is disposed a reactant material for generating the gaseous reagent. The fluid supply vessel is coupled with a valve head, which may be coupled in turn by associated flow circuitry with sources of carrier gas and/or reactant(s) that are reactive with the reactant material, and the valve head may also be coupled with an ancillary reaction chamber for effecting the reaction to generate the gaseous reagent. The fluid supply vessel may optionally be provided with a heater, e.g., in the form of a heating jacket surrounding the vessel casing, to volatilized the reactant material in the fluid supply vessel.

Such fluid supply package may be employed to achieve high volume, low cost of ownership delivery of toxic or otherwise hazardous gases, and the fluid supply vessel may be filled with a solid source reactive material to achieve a high-volume supply of the product gaseous reagent.

As an illustrative example, such fluid supply package may include a fluid supply vessel containing a bed of arsenic solids. An external hydrogen source may be employed to produce arsine as a product gaseous reagent, by reaction with the arsenic solids. The fluid supply vessel may be provided with a heater to generate arsenic vapor from the arsenic solids, and the valve head of the fluid supply package may be coupled at its discharge port with a catalytic reaction chamber containing catalyst effective for the arsenic production reaction, whereby an efficient and high yield of arsine production is achieved.

Referring now to the drawings, FIG. 15 is a schematic elevation view of a fluid supply package configured for point of use generation of a product gaseous reagent, according to one embodiment of the present disclosure.

The fluid supply package 460 includes a fluid supply vessel 462 that is coupled with a valve head 464. The fluid supply vessel 462 includes a vessel casing 466, which encloses an interior volume 468 in which is disposed a bed 470 of arsenic particles. The fluid supply vessel is circumscribed by a heating jacket 506, which may be utilized to generate arsenic vapor from the bed of arsenic particles.

The valve head 464 includes a valve head body 472 with a fill port 474 and discharge port 476. The valve head body 472 as a fill tube 480 secured thereto in communication with the fill port 474, to introduce fluid into the interior volume 468 of the vessel. The vessel also includes a dispensing gas conduit 482 that is coupled to a fluid dispensing assembly 484. The fluid dispensing assembly 484 may be of any suitable type, as herein disclosed in connection with other embodiments of the disclosure, and may for example include one or more filters, check valves, pressure regulators, leak prevention assemblies, etc. as appropriate for a given application of such fluid supply package. The dispensing gas conduit 482 and fluid dispensing assembly 484 communicate with a passage and valve cavity in the valve head in which is disposed a valve element that can be modulated between fully open and fully closed positions by the valve actuator 478, which may be of any suitable type as described in connection with other embodiments of the present disclosure.

The valve head body at the discharge port 476 is coupled to a catalytic reaction chamber 502 in which reaction of arsenic vapor and hydrogen is carried out or completed, to produce arsine gas that is discharged in arsine discharge line 504. The valve head body at the fill port 474 is joined to flow circuitry for introducing hydrogen reactant gas and/or argon carrier gas into the interior volume 468 of the fluid supply vessel. An argon source 486 and a hydrogen source are provided, to supply argon gas and hydrogen gas, respectively. The argon source 486 is coupled to argon feed line 494 containing flow control valve 492 therein, for flowing argon gas as a carrier gas to the fill port 476 of the valve head for subsequent introduction in fill tube 482 the interior volume 468 of the vessel 462.

The hydrogen source 488 is coupled to flow circuitry including hydrogen feed line 490 containing flow control valve 500 therein, and hydrogen feed branch line 496 containing flow control valve 498 therein which connects to the argon feed line 494, as illustrated.

By this arrangement, the fluid supply package can be operated by flow of argon carrier gas in argon feed line 494 to the valve head and into the enclosed interior volume of the vessel for contact with the arsenic solids, which may be heated to form arsenic vapor that is entrained in the argon carrier gas and subsequently flowed through the dispensing gas conduit 482 and fluid dispensing assembly 484 to the catalytic reaction chamber 502. Hydrogen maybe flowed in hydrogen feed line 490 from hydrogen source 488 to the catalytic reaction chamber 502, with flow control valve 500 being open for such purpose, so that hydrogen warm arsenic vapor are contacted in the catalytic reaction chamber in the presence of suitable catalyst therein, to generate arsine as a product gas that then is discharged from the catalytic reaction chamber to the arsine discharge line 504 and flowed to a downstream arsine-utilizing facility.

Additionally, or alternatively, hydrogen from hydrogen source 488 may be flowed to hydrogen feed line 490 and hydrogen feed branch line 496, flow control valve 498 being open, so that hydrogen gas mixes with argon carrier gas in argon feed line 494 and the resulting gas mixture of hydrogen and argon is flowed to the valve head and fill tube 480 for contacting with the vapor deriving from the arsenic solids in the vessel 462. Such contacting results in reaction of the hydrogen gas with arsenic solids to form arsine in the argon carrier gas so that the arsine-argon gas mixture then flows through the dispensing gas conduit 482 and fluid dispensing assembly 484 to the to the catalytic reaction chamber 502 wherein any residual reactant is reacted to achieve high yield of arsine in the gas mixture that then is discharged in arsine discharge line 504 and flowed to the downstream arsine-utilizing facility.

By this arrangement, hydrogen can be diluted in the argon carrier gas so that the reaction can be carried out in the fluid supply vessel 462 to produce arsine in the carrier gas, as a mixture suitable for ion implantation of arsenic, or for other applications for which the product gas mixture is appropriate. Alternatively, hydrogen can be directly catalytically reacted with arsenic vapor. In some instances, the carrier gas flow control valve 492 may be closed, or the carrier gas source may be eliminated from the overall fluid supply package, so that the package supplies high purity arsine gas for subsequent use.

The various valves in the flow circuitry associated with the fluid supply package may be of any suitable type, and may for example be coupled with a central processor unit (CPU) or other controller to carry out the generation of arsine according to a cycle time program or other programmatic methodology. It will therefore be apparent that the fluid supply package may be variously configured and automated, to provide the product gas in a direct and simple manner for point of use consumption thereof.

A further aspect of the disclosure relates to a fluid supply package for deployment in an environment susceptible to sudden heat and/or fire events, said fluid supply package comprising a fluid supply vessel coupled to a valve head, and an insulative cover on the fluid supply vessel and the valve head, which is effective to maintain the fluid supply package for an extended period of time without rupture in the event of a fire or other high temperature exposure. The insulative cover may comprise superinsulation.

In a related aspect, the disclosure relates to a gas box assembly for holding fluid supply packages to dispense gases an ion implanter apparatus, said gas box assembly comprising a gas box, and an insulative cover on the gas box, which is effective to maintain the gas box for an extended period of time without rupture of fluid supply packages therein, in the event of a fire or other high temperature exposure.

The disclosure thus provides a fluid supply package that comprises an insulative cover that is effective to maintain the fluid supply package for an extended period of time without rupture in the event of a fire or other high temperature exposure. Additionally, or alternatively, this aspect of the disclosure relates to a gas box configured for holding fluid supply packages, in which the fluid supply packages, or the gas box, or both are insulated in such manner, to avoid catastrophic releases of gas in the event of fire or other high temperature exposure.

The insulation may be of any suitable type, and may for example comprise superinsulation that is effective to achieve an extended time fire rating for the fluid supply package and/or gas box.

In the event of a fire, the fluid supply packages can become overpressured by the high temperature exposure. In some cases, the fluid supply packages will rupture, resulting in large hazardous gas releases and hazardous material spills when the contained fluid is of a toxic or otherwise hazardous character. The use of fluid supply packages in ion implantation operations carries particular danger, since the implant gas fluid supply packages are located inside the implanters, and cannot be cooled by sprinklers due to the high voltage character of the implanter. This circumstance entails a large potential and primal safety and health hazard and a correspondingly extensive clean up problem.

By placing a high-efficiency insulation layer on the fluid supply package, or around the gas box in which the fluid supply package resides, or both, the temperature of the fluid supply package can be kept fairly low during a fire event, for a period of time that is adequate to enable firefighters and/or firefighting processes to overcome the fire emergency. The duration of the protective period enabled by the insulation can be from several minutes to many hours, depending on the character of the insulative cover that is applied to the fluid supply package and/or gas cabinet. By such provision, catastrophic releases of hazardous gas and/or toxic material spills can be avoided by use of insulative materials that are commensurate with the potential extent and conditions of the fire hazard and associated fire events.

As an illustration, the fluid supply package may be encased in an insulative jacket similar to that shown in FIG. 7 but additionally extending over the valve head so that all components of the fluid supply package are covered by insulation of appropriate character to provide the extended duration fire protection to the fluid supply package. In the case of a gas box, single or multiple layers of insulation may be applied over all gas box surfaces, interiorly and/or exteriorly, as appropriate to maintain temperature of the fluid supply packages in the gas box at levels commensurate with maintenance of structural integrity of such packages, and which avoid vessel leakage as a result of pressure increases and sent to heating of the fluid contents of the fluid supply packages.

Another aspect of the disclosure relates to a fluid supply package comprising a fluid supply vessel coupled to a valve head arranged for dispensing gas from the fluid supply vessel, an overpressure sensor configured to detect an overpressure condition of fluid in the fluid supply package and responsively output an overpressure condition signal, and a protective closure valve that is configured to close in response to the overpressure condition signal from the overpressure sensor.

The overpressure sensor may comprise one or more strain gauges mounted on a structural portion of the fluid supply package. For example, the overpressure sensor may be mounted on an exterior surface of the fluid supply vessel. Alternatively, or additionally, an overpressure sensor may be mounted on a discharge conduit coupled to the valve head of the fluid supply package. The protective closure valve in a specific embodiment may be disposed on a discharge conduit coupled to the valve head of the fluid supply package. In various embodiments, the protective closure valve may comprise a valve in the valve head of the fluid supply package. In various embodiments, the overpressure sensor may be configured to output an overpressure condition signal in response to pressure above subatmospheric pressure.

Thus, the disclosure provides a fluid supply package equipped with a protective closure valve, e.g., an anti-backfill closure valve, and overpressure sensor that is operatively coupled with the protective closure valve to avoid overpressure conditions in the fluid supply vessel. The overpressure sensor may comprise a strain gauge that is surface mounted on an external surface of the vessel casing, and/or a strain gauge that is mounted at one or more positions along a discharge port of the package and operatively linked to the protective closure valve. Upon sensing of overpressure in the fluid supply package by one or more of the strain gauge arrangements just described, the strain gauge transmits a responsive pressure sensing signal indicative of the overpressure condition to a pressure sensing signal-responsive protective closure valve, which thereupon closes to prevent backfilling or other condition that may result in further overpressuring of the package, subsequent expulsion of pressurized gas from the package, or damage to the package or associated instrumentation, monitoring and control components, etc.

The foregoing fluid supply package arrangement has applicability to fluid supply packages that are designed for dispensing of gas at subatmospheric pressure. Such fluid supply packages have the potential to be inadvertently back-filled with higher pressure inert or process gases. Back-filling can result in contaminated fluid supply vessels of such packages, or in a worst-case scenario, breached integrity of the fluid supply package. Overdesign of fluid supply packages with increased thickness vessel walls and higher pressure rated components, as a safeguard against such overpressuring events, introduces substantial added cost and complexity to the manufacture of the fluid supply package.

Using an overpressure sensor such as a strain gauge to monitor pressure in the fluid supply package and actuating a shutoff valve in the event of overpressure, in accordance with this aspect of the present disclosure, achieves a simple and reliable solution to the issue of overpressure events. Thus, the protective valve may be preset to close at a pressure that is commensurate with the storage and dispensing pressure for the fluid supply package. When such storage and dispensing pressure are at subatmospheric levels, the protective valve may be preset to close at pressure that is equal to or above 1 atm. Such arrangement prevents backfilling of the fluid supply vessel with foreign gases, and serves to avoid small releases that might be possible due to excess heat or decomposition of contained gas during storage, transit, or installation in a fluid utilization facility.

The overpressure sensor can be deployed at any suitable location or locations on the fluid supply package. In the case of a strain gauge overpressure sensor, the sensor can be surface mounted on an exterior surface of the vessel casing of the fluid supply vessel, or be deployed on the valve head or the surface of a discharge port of the package. The overpressure sensor and responsive protective valve can be usefully employed with adsorbent-based fluid supply packages, as well as with internally pressure-regulated packages and packages that combine both adsorbent storage of gas and internal pressure-regulation in the fluid supply vessel, and with other fluid supply packages that are susceptible to overpressure events in the course of their use.

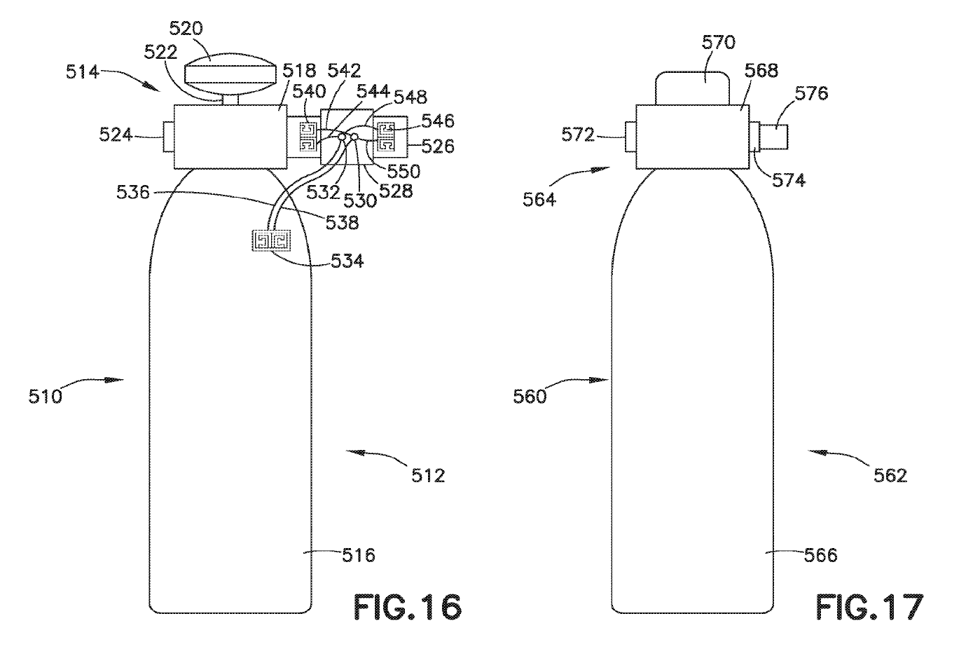

Referring now to the drawings, FIG. 16 is a schematic elevation view of a fluid supply package utilizing strain gauge overpressure sensors operatively linked with a protective valve. In this arrangement, the protective valve is responsive to overpressure signals from the strain gauge overpressure sensors, functioning to close the fluid supply package to fluid communication and to interchange with an ambient environment of the package.

As illustrated in FIG. 16, the fluid supply package 510 includes a fluid supply vessel 512 coupled with a valve head 514. The vessel casing 516 of the vessel encloses an interior volume that may contain adsorbent and/or a fluid dispensing assembly for controlled release of gas from the package. The valve head 514 includes a valve head body 518 containing an internal valve (not shown in FIG. 16) which is coupled by stem 522 to the hand wheel 520, for modulating the internal valve in the valve head between fully open and fully closed positions. Alternatively, in lieu of the hand wheel, a valve actuator of automatic character may be employed, such as for example a pneumatic valve actuator, a solenoid valve actuator, or other automatic valve actuator type.

The valve head body 518 includes a fill port 524 for charging fluid to the fluid supply vessel, as well has a discharge port 526, which is shown is of elongate character, comprising a discharge conduit in which is disposed protective closure valve 528, as an anti-backfill closure valve. The protective closure valve is equipped with signal terminals 530 and 532 to which signal transmission wires from overpressure sensors may be secured, for initiating closure of the protective closure valve in response to overpressure signals transmitted by such signal transmission lines.

The overpressure sensors shown in the FIG. 16 embodiment are strain gauge sensors. A strain gauge 534 is shown as being surface mounted on an exterior surface of the vessel casing 516, and coupled by signal transmission wires 536 and 538 to the respective terminals of the protective closure valve, so that when the strain gauge 534 senses and overpressure condition, it transmits overpressure signals to the protective closure valve 528 so that it closes.

As alternative or additional overpressure sensing components, the discharge port 526 may be provided with a strain gauge 540 mounted thereon adjacent to the valve head body 518, coupled to the protective closure valve 528 by signal transmission wires 542 and 544, and/or the discharge port may be provided with a strain gauge 546 at an end portion thereof, coupled to the protective closure valve 528 by signal transmission wires 548 and 550. It will be recognized that the number and placement of overpressure sensors on the fluid supply package may be widely varied in the broad practice of the present disclosure, and that such overpressure sensors may be of any of widely varying types that are effective to sense overpressure conditions in the fluid supply package and to responsively output signals indicative of such conditions, to actuate a protective closure valve.

It will also be recognized that the overpressure protection assembly may also utilize the valve in the valve head body as the protective closure valve, in addition to, or in place of, another valve or valves in the fluid supply package.

A further aspect of the disclosure relates to a fluid supply package, comprising a fluid supply vessel coupled to a valve head, the valve head including a fluid discharge port to discharge fluid from the fluid supply vessel, and a flow control occlusion device leak-tightly and removably installed in the fluid discharge port, to prevent flow communication of the fluid discharge port with an external source of fluid.

The flow control occlusion device may for example comprise a check valve that is preset for subatmospheric pressure operation to prevent backfilling of the fluid supply package with contaminating or otherwise extraneous gases. Alternatively, or additionally, the flow control occlusion device may comprise regulator device configured to prevent backfilling of the fluid supply package with contaminating or otherwise extraneous gases.

Thus, the disclosure provides a fluid supply package including a fluid supply vessel coupled to a valve head including a fluid discharge port including a flow control occlusion device that is leak tightly and removably installed in the fluid discharge port, to prevent flow communication of the fluid discharge port with an external source of fluid. In one embodiment, the flow control occlusion device may be a check valve that is preset for subatmospheric pressure operation thereby preventing backfilling of the fluid supply package with contaminating or otherwise extraneous gases. In other embodiments, the flow control occlusion device may be a regulator device that operates to prevent backfilling of the fluid supply package with contaminating or otherwise extraneous gases. The regulator device may be of a mechanical, e.g., spring loaded type, a set point regulator type, e.g., including a bellows assembly and poppet valve, or a microelectromechanical system (MEMS) type.

The fluid discharge port may be structurally adapted to the flow control occlusion device. For example, the fluid discharge port may be threaded or provided with other complementary structure to which the flow control occlusion device may be leak tightly coupled with the fluid discharge port, e.g., by complimentary threading, or a quick-disconnect fitting on the occlusion device.

The flow control occlusion device thus can be readily removed to allow filling of the fluid supply package, when the discharge port is the only port provided in a single port valve head, and is utilized for filling of the fluid supply package with fresh fluid. It can also be removed to facilitate installation of the fluid supply package in a fluid-utilizing facility. The flow control occlusion device can be formed as a single-use item, e.g., as a check valve set for subatmospheric pressure operation and formed of an inexpensive biodegradable plastic, or other suitable material, or the flow control occlusion device can comprise a regulator device that is utilized throughout the life of the vessel, and for such purpose, the occlusion device may be secured to the neck or valve head of the fluid supply package to facilitate its ready reuse.

Referring now to the drawings, FIG. 17 shows an elevation view of a fluid supply package 560 including a fluid supply vessel 562 coupled to a valve head 564. The fluid supply vessel 562 includes a vessel casing 566 enclosing an interior volume of the vessel in which adsorbent and/or a fluid dispensing assembly may be deployed, as described in connection with other embodiments of the present disclosure. The valve head 564 includes a valve head body 568 containing a valve that is actuatable by valve actuator 570, of suitable type, with a fill port 572 and a fluid discharge port 574, which is shown with the flow control occlusion device 576 leak tightly installed in the fluid discharge port to prevent flow communication with the ambient environment of the package.

It will be recognized that the flow control occlusion device may be widely varied in structure and motive engagement with the fluid discharge port of the fluid supply package.

In another aspect, the disclosure relates to a fluid supply package comprising a fluid supply vessel coupled to a valve head for dispensing of fluid from the fluid supply vessel, wherein the valve head comprises a pneumatic valve and is dimensionally sized to enable placement of the fluid supply package in an ion implanter gas box.

The fluid supply package may comprise an adsorbent-based fluid supply vessel, as an illustrative fluid supply package that may be installed in an ion implanter gas box. The ion implanter gas box in such aspect may comprise a pneumatic valve block and pneumatic flow circuitry for modulating the pneumatic valve in the valve head of the fluid supply package.

Thus, the disclosure provides a fluid supply package comprising a fluid supply vessel coupled to a valve head, in which the valve in the valve head is a pneumatic valve with a low profile that is similar to dimensions of manual valves, so that the fluid supply package can be installed in a standard ion implanter gas box, which typically is not designed to accept a pneumatic valve package. The pneumatic valve in the valve head would comprise a valve diaphragm that would be rated at high pressure, e.g., on the order of 3000 psig, in the event that the gas line associated with the fluid supply package were charged with high pressure gas.

In adsorbent-based fluid supply packages fabricated to dispense gas under dispensing conditions at subatmospheric pressures, pressure in the fluid supply vessel is typically specified not to exceed a predetermined value, as for example a maximum value of 58 psig. To provide a corresponding safety factor of twice such maximum value, the pneumatic valve can be fabricated with a maximum valve seat sealing pressure of 120 psig. Under such specification, the cross port pressure rating of the valve can be reduced from a high value on the order of 3000 psig to the 100 psig specification, which in turn allows the force of the main spring in the valve to be reduced, so that a smaller sized pneumatic actuator can be employed. If the gas line associated with the ion implanter facility were to be back filled with high pressure gas, then the valve seat would compress against the valve body and provide an even better seal.

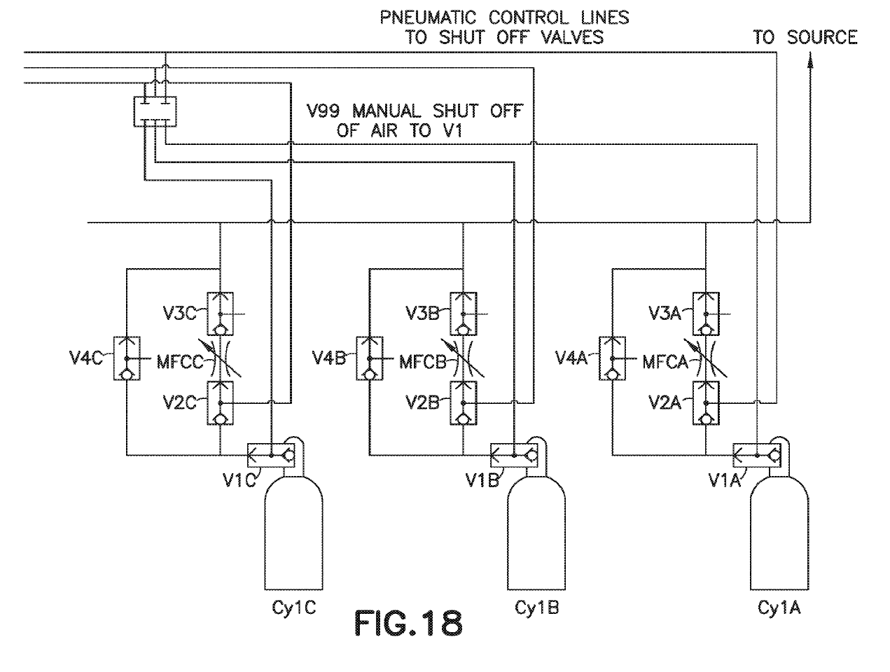

The corresponding fluid supply package featuring the low profile pneumatic valve can be employed in a gas box of an ion implanter in which a separate pneumatic valve block is installed, as shown in the schematic gas box system illustrated in FIG. 18. In such FIG. 18 gas box system, each of the fluid supply packages (Cylinder A, Cylinder B, and Cylinder C) in the gas box has a corresponding pneumatic valve V1 (V1A in Cylinder A, V1B in Cylinder B, and V1C in Cylinder C). Each of the fluid supply packages is joined to a dispensing manifold for flowing the dispensed gas to the downstream ion source of the ion implanter. Each of the dispensing manifold sections associated with a fluid supply package includes an upstream flow control valve V2 and a downstream flow control valve V3, intermediate which is a mass flow controller (MFC), and with the flow circuitry including a bypass loop around such mass flow controller, in which the bypass loop includes bypass valve V4. By providing a pneumatic valve on the fluid supply package, the package can be isolated from the vacuum system of the ion implanter when not in use, thereby eliminating the possibility of back flow of gas into the fluid supply package.

Alternatively, the pneumatic line can be disconnected from only a fluid supply package that requires replacement, and such approach can remove the requirement of the V99 manual shut off of air to the pneumatic valve of the fluid supply package. A technician utilizing such system would still need to lock out the pneumatic line to the fluid supply package, but since the fluid supply package valve is pneumatic, it is never over-torqued in a closed or open position, as can happen with manual valves. When the pneumatic line is disconnected, the pneumatic valve is closed.

Thus, the FIG. 18 gas box system during normal implant operations is operated with the V99 manual air shut off valve open, allowing the pneumatic control line for the valve V2 in the fluid dispensing manifold to also open the pneumatic fluid supply package valve V1. Before a change out of a fluid supply package, the V99 manual shut off valve is closed and the depleted fluid supply package is removed from the manifold and replaced by a fresh fluid supply package. After the fluid supply package change out has been completed, the V99 manual shut off valve can again be opened.

The FIG. 18 gas box system thus accommodates fluid supply packages equipped with pneumatic package valves in a simple and effective manner.

A further aspect of the disclosure relates to a fluid supply package, comprising a fluid supply vessel coupled to a valve head and regulator assembly for dispensing of fluid from the vessel, the valve head and regulator assembly comprising an external adjustable pressure regulator and a dispensing valve communicating with a discharge port, arranged so that during dispensing the fluid flows through the external adjustable pressure regulator prior to flow through the dispensing valve of the assembly to the discharge port, and the fluid supply vessel having internally disposed therein a gas stick comprising at least one pressure regulator or pressure actuated check valve and arranged to flow gas from the fluid supply vessel to the valve head and regulator assembly.

The gas stick may for example comprise one pressure regulator, or alternatively the gas stick may comprise two pressure regulators in series. In other embodiments, the gas stick may comprise a pressure actuated check valve, e.g., with a capillary tube assembly, arranged so that fluid flows through the capillary tube assembly prior to the pressure actuated check valve.

The fluid supply package may in various embodiments contain an adsorbent fluid storage medium, e.g., a carbon adsorbent. The fluid supply package in various embodiments may be configured for dispensing of fluid at subatmospheric, or alternatively at superatmospheric, pressure.

The above-described fluid supply package may be coupled with fluid flow circuitry for delivery of dispensed fluid to a fluid-utilizing facility, and further comprising a monitoring and control system configured to monitor a condition of dispensed fluid in the fluid flow circuitry and to responsively adjust the external adjustable pressure regulator to maintain a predetermined fluid condition. The monitoring and control system may for example be configured to monitor pressure of dispensed fluid in the fluid flow circuitry.

Thus, the disclosure provides a fluid supply package that is internally as well as externally pressure-regulated to provide fluid at a predetermined pressure. The fluid supply package includes a fluid supply vessel that is coupled to a valve head and regulator assembly including an external adjustable pressure regulator. The fluid supply vessel as internally disposed therein a gas stick that includes at least one pressure regulator or pressure actuated check valve. The stick may further comprise a filter, particle exclusion membrane, or a capillary tube assembly. By such arrangement, the fluid supply package includes at least one set point flow control device in the interior volume of the vessel, in addition to the external set point flow control device in the form of an adjustable pressure regulator that can be adjusted to a desired set point, so that the fluid supply package thereby is able to dispense fluid at a desired pressure level, which may be superatmospheric, atmospheric, or subatmospheric in character.

This arrangement provides a package configuration that can utilize an integrated internal regulator assembly of series-arranged pressure regulators in the interior volume of the fluid supply vessel, or alternatively a pressure actuated check valve and capillary assembly in the interior volume, or other fluid dispensing stick configuration of interiorly disposed dispensing components, in combination with an externally adjustable pressure regulator that is integrated with the valve head. Accordingly, such arrangement provides a pressure-regulated internal gas stick that can deliver gas of a predetermined pressure to the external regulator that is adjustable to enable the final discharge port pressure of the dispensed gas to be varied over a specific range accommodated by the external regulator, to allow adjustability of the final delivery pressure of gas, depending on the specific application or use for which the gas is to be dispensed. The external regulator may be adjustable in any suitable manner, as for example by a manual control on the valve head and regulator assembly, or by use of a special tool, as appropriate to the specific application or use.

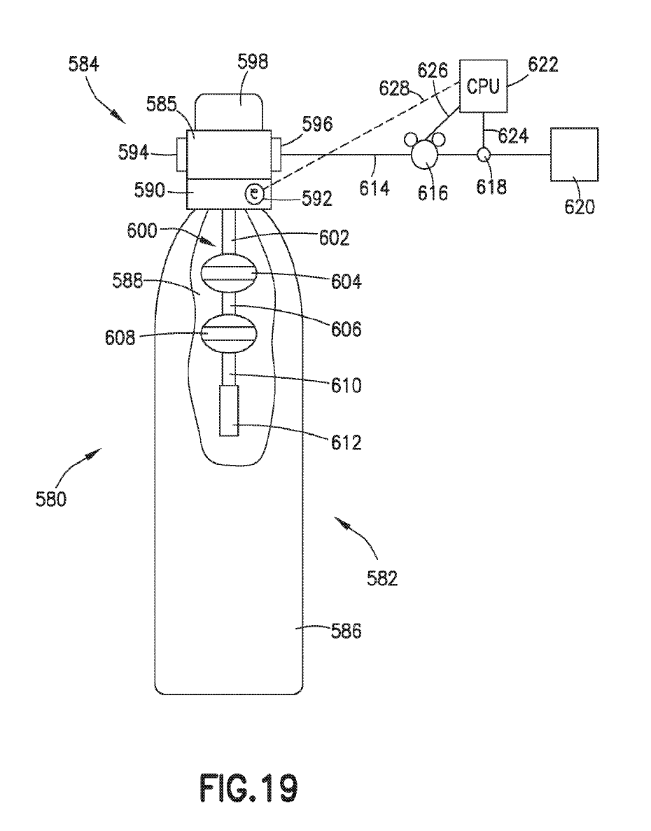

Referring now to the drawings, FIG. 19 is a schematic elevation view of a fluid supply package, partially broken away to show the details of the internal fluid dispensing stick, comprising a fluid supply vessel coupled with a valve head and regulator assembly in which the regulator in such assembly is external to the fluid supply vessel and externally adjustable to provide a selected set point for fluid dispensing.

As illustrated in FIG. 19, the fluid supply package 580 includes a fluid supply vessel 582 coupled to the valve head and regulator assembly 584. The vessel 582 includes a vessel casing 586 defining floor, sidewall and neck portions of the vessel and enclosing an interior volume 588, in which is disposed fluid dispensing stick 600.

The fluid dispensing stick 600 includes an upper dispensing conduit 602 that is in flow communication with the externally adjustable regulator 590 of the valve head and regulator assembly 584. The upper dispensing conduit 602 is joined at its lower end to internal downstream regulator 604, which in the embodiment shown is coupled by intermediate dispensing conduit 606 to the internal upstream regulator 608. As previously discussed, the dispensing stick 600 may comprise a single regulator, or multiple (two or more) regulators, or one or multiple pressure actuated check valves. The internal upstream regulator 608 is coupled at its lower extremity to lower dispensing conduit 610. The lower dispensing conduit in turn is secured to filter or capillary tube assembly 612 in the illustrated embodiment.

The filter 612 may comprise a sintered matrix frit element having porosity that is effective to occlude particulate matter from being entrained in the fluid being dispensed by the gas stick, or the filter may comprise a permeable membrane as elsewhere described herein. Alternatively, the element 612 may comprise a capillary tube assembly, comprising an array of parallelly oriented capillary tubes, having lower (through which fluid enters the dispensing stick from the bulk volume of fluid in the vessel.

As a further variation, the vessel 582 may further contain adsorbent having sorptive affinity for the gas to be dispensed from the fluid supply package. Such adsorbent may be of any suitable type, as elsewhere herein described in connection with other embodiments of the present disclosure.

The valve head and regulator assembly 584 comprises the externally adjustable regulator 590, as previously noted, as integrated with the valve head body 585. The valve head body includes a fill port 594 and a discharge port 596. The valve head in turn is coupled with a valve actuator 598, which may be of a pneumatic, solenoid, manual, or other type, is also elsewhere described herein. The externally adjustable regulator 590 is provided with a regulator adjustment mechanism 592 that may be operated manually or automatically, and may in specific embodiments be configured for operation with a specialized mechanical tool, by wireless signal transmission capability, or in other suitable manner enabling adjustment of the set point pressure of fluid delivered to such externally adjustable regulator from the fluid dispensing stick 600.

In operation of the fluid supply package shown in FIG. 19, the dispensing valve (not shown in FIG. 19) in the valve head body 585 may be actuated by valve actuator 598 to open the dispensing valve in the valve head body, to initiate flow of gas from the vessel 582. Gas flows through the filter or capillary tube assembly 612, upwardly through the lower dispensing conduit 610 to internal upstream pressure regulator 608, which pressure regulates the gas to lower pressure, with the lower pressure gas flowing in intermediate dispensing conduit 606 to the internal downstream pressure regulator 604, which pressure regulates the gas to still lower pressure, with the still lower pressure gas flowing in a dispensing conduit 602 to the externally adjustable regulator 590, in which the gas is regulated to a lower dispensing pressure.

The lower dispensing pressure gas then flows to the valve in valve head body 585 and is discharged from the valve head body at discharge port 596. The discharge port 596 may be coupled to flow circuitry for delivery of the dispensed gas to a downstream gas-utilizing process system or location.

As indicated, variations of the fluid supply package shown in FIG. 19 are contemplated, in which the fluid dispensing stick 600 may be variously configured with any suitable number(s) of fluid flow control devices, including regulators, pressure activated check valves, particle filters such as sintered metal frit elements or particle occlusion membranes, capillary tube assemblies, etc., in which the respective fluid flow control devices are coupled with one another by conduits or other flow passage structures, so that the gas being dispensed flows sequentially through the respective components of the fluid dispensing stick and flows from the fluid dispensing stick to the externally adjustable regulator, and from the externally adjustable regulator to the dispensing valve in the valve head of the fluid supply package. As indicated, the externally adjustable regulator can be adjusted to provide any desired dispensing pressure level for the dispensed gas, including subatmospheric, atmospheric, and superatmospheric pressures, as necessary or advantageous in a given application of such fluid supply package.

In a further aspect, the disclosure relates to an internally pressure regulated fluid supply package configured to attenuate fluid output spiking and oscillation behavior, said fluid supply package comprising a fluid supply vessel coupled to a valve head including a discharge port for dispensing of fluid from the vessel, the fluid supply vessel having internally disposed therein a gas stick comprising at least one pressure regulator or pressure actuated check valve and arranged to flow gas from the fluid supply vessel to the valve head, wherein: (i) a pressure regulator or pressure actuated check valve that is located prior to any other pressure regulator or pressure actuated check valve in the gas stick is set so that its delivery pressure is below a delivery pressure at which fluid output spiking and oscillation behavior can occur, and/or (ii) the fluid supply package comprises at least one external pressure regulator, which is (A) integrated with the valve head in a valve head and regulator assembly comprising the external adjustable pressure regulator and the valve head, arranged so that during dispensing the fluid flows through the external adjustable pressure regulator prior to flow through the valve head in the assembly, or (B) coupled to the discharge port of the valve head.

Accordingly, various permutations of the fluid supply package are contemplated, including configurations comprising all possible permutations of (i), (ii)(A), and (ii)(B).

The gas stick may comprise two pressure regulators in series, e.g., wherein an upstream one of the two pressure regulators in series is set so that its delivery pressure is in a range of from 45 psia to 105 psia.

In other embodiments, the gas stick comprises a capillary tube assembly prior to a pressure actuated check valve.

The fluid supply package in various implementations may further comprise a pressure-damping device disposed in a gas flow path of the fluid supply package, such as a device selected from the group consisting of restricted flow orifice elements, filters, frits, and permeable membranes.

The fluid supply package may be arranged in various implementations to deliver fluid to a fluid-utilizing facility, such as a fluid-utilizing facility selected from the group consisting of semiconductor manufacturing facilities, solar panel manufacturing facilities, and flat-panel display manufacturing facilities.

In other implementations, the fluid supply package may be coupled with fluid flow circuitry for delivery of dispensed fluid to a fluid-utilizing facility, and further comprising a monitoring and control system configured to monitor a condition of dispensed fluid in the fluid flow circuitry and to responsively adjust the external pressure regulator to maintain a predetermined fluid condition. For example, the monitoring and control system may be configured to monitor pressure of dispensed fluid in the fluid flow circuitry.

Thus, the disclosure contemplates an internally pressure regulated fluid supply package in which (i) delivery pressure of a highest pressure regulator component is set or modulated so that it is below a delivery pressure of the regulator component at which fluid output spiking and oscillation behavior can occur, and/or (ii) an external pressure regulator component is provided, which may be integrated with the valve head as in the previously discussed aspect of the disclosure, or which may be disposed in the flow circuitry coupled to a discharge port of the fluid supply package, and is adjustably set or modulated so as to attenuate such fluid output spiking and oscillation behavior.

Such fluid supply package arrangement addresses the issue that in internally pressure-regulated fluid supply packages, the pressure regulators may in some instances exhibit single or multiple pressure spiking behavior when gas is flowed therethrough. Such spiking behavior can lead to flow rate fluctuations. In applications such as ion implantation, in which the dispensed gas is utilized to generate ions for implantation, such flow rate fluctuations can in turn lead to fluctuations in the ion beam current of the ion implanter, and consequently to potential non-uniform doping of a wafer or other substrate.

The aforementioned anomalous flow phenomena can occur in fluid supply packages that are internally pressure regulated with series-arranged pressure regulator devices, as well as fluid supply packages that are internally pressure regulated with other fluid flow control components.

In internally pressure-regulated fluid supply packages containing a series arrangement of pressure regulators in the internal gas stick in the fluid supply vessel, it has been found that spiking behavior and oscillations can be eliminated by reducing delivery pressure of a “highest pressure” pressure regulator, i.e., the pressure regulator that experiences the highest gas pressure from the bulk fluid volume in the fluid supply vessel, so that such regulator achieves a reduction in pressure from such highest pressure level to a pressure that is below a pressure (the “anomalous flow critical pressure”) at which such spiking behavior and oscillations can occur.

In various internally pressure regulated fluid supply packages in which two pressure regulators are utilized in series to provide sequential pressure reductions in the respective regulators as the gas flows through the upstream regulator and thereafter to the downstream regulator to provide gas at subatmospheric pressure for dispensing (so that the downstream regulator has an output pressure that is less than 1 atm), it has been found that the anomalous flow critical pressure is in a range of from 45 psia to 105 psia, and that when the upstream regulator set point is set to provide an output pressure in such anomalous flow critical pressure range, such spiking behavior and consequent gas stream oscillations are substantially attenuated.

It will be recognized that the foregoing anomalous flow critical pressure range will vary depending on the number and type of pressure regulators utilized in the internally pressure regulated vessel of the fluid supply package, and that such pressure range can be empirically determined by simple fluid monitoring tests to determine the regime in which spiking and oscillations occur, and the regime in which such anomalous flow behavior is attenuated.

In addition, operation of the upstream regulator to provide an output pressure below the anomalous flow critical pressure range is also beneficial to mitigate initial pressure spikes, typically single or double spikes, that may occur in the delivered gas stream when a regulator poppet valve element first opens in response to a flow command of a mass flow controller to initiate dispensing operation.

In an alternative, or additional, approach to attenuating pressure spikes and oscillation behavior in the dispensed gas stream, and external pressure regulator, outside of the fluid supply vessel, may be employed. Such external pressure regulator may be integrated into the valve head of the fluid supply vessel, as previously described with reference to FIG. 19, or the external pressure regulator may be disposed in the flow circuitry for delivery of the dispensed gas to a gas-utilizing facility, or external pressure regulators may be provided both in the valve head assembly of the fluid supply package as well as in the flow circuitry coupled to the discharge port of the fluid supply vessel in dispensing operation.

As previously discussed in connection with FIG. 19, the external pressure regulator integrated in the valve head assembly of the fluid supply package is of an adjustable character, and can be selectively adjusted to provide a specific output pressure of the dispensed gas. In like manner, the external pressure regulator disposed in the flow circuitry coupled with the fluid supply package may be of an adjustable character. By such adjustability, gas at pressure level appropriate to the end use can be provided, and the additional external pressure regulator(s) will act to further damp or eliminate pressure spikes incident to initial gas flow or oscillatory fluid flow behavior occurring during ongoing dispensing operation.

Thus, a series of pressure regulators is provided in the overall gas flow path including the gas stick fluid flow path in the fluid supply package and externally of the fluid supply vessel, in the valve head assembly of the fluid supply package and/or in the flow circuitry gas flow path of the fluid after it is dispensed from the fluid supply package. In such overall gas flow path, each succeeding regulator effects a further reduction in pressure of the gas to achieve a final delivery pressure in the dispensed gas that is utilized in the gas-utilizing facility associated with the fluid supply package. The set points of successive setpoint pressure regulators are set to achieve such “step down” of pressure, with the respective set points are at successively lower pressure levels.

The adjustability of the external pressure regulators is also advantageous to “turn down” pressure levels of the gas at the outlets of such regulators, to levels that are consistent with uniform hydrodynamic flow behavior of the dispensed gas.

The adjustable external pressure regulators in such arrangements may be modulated for adjustment of setpoint in any suitable manner, e.g., by fluidic, electrical, or wireless signal adjustment modes. Thus, the external regulators can be wiredly or wirelessly coupled to a central processor unit that is configured to adjust the regulator set point of the external regulators, and such processor unit may be part of a monitoring and control system in which fluid pressure is monitored in the overall gas flow path, e.g., in the flow circuitry downstream of the external regulator(s) and pressure monitoring signals are transmitted to the central processor unit 4 responsive transmission of control signals to the external regulator(s).

For example, a pressure regulator of a type incorporating a pressure sensing assembly and associated poppet valve may be fluidically modulated by coupling the pressure sensing assembly with an inert pressure sores configured to increase or decrease the pressure sensing assembly pressure and thus the delivery pressure of the regulator in response to some form of feedback control, such as in response to monitored downstream gas pressure.

In addition to the foregoing approaches to attenuate anomalous flow behavior in the dispensing of gas from internally pressure-regulated fluid supply packages, pressure-damping devices may be disposed in the gas delivery line or otherwise in the overall gas flow path to attenuate spiking and oscillation behavior of the dispensed fluid. Such pressure-damping devices may include, without limitation, restricted flow orifice elements, filters, frits, permeable membranes, and the like, whose character and placement can be readily determined by empirical effort, has effective to attenuate the anomalous spiking and oscillation flow behavior.

Referring again to FIG. 19, the previously described fluid supply package is shown as being coupled to dispensed gas flow circuitry in the form of gas dispensing line 614, which may be connected to the discharge port 596 of the fluid supply package, as illustrated. The gas dispensing line 614 delivers the dispensed gas to a gas utilizing facility 620, which may for example comprise a semiconductor manufacturing facility, or a manufacturing facility for production of solar panels or flat-panel displays. The gas dispensing line 614 contains an adjustable pressure regulator 616 therein as a further external pressure regulator, downstream of which is a pressure transducer 618. In the arrangement shown, a CPU 622 is provided as part of a monitoring and control system associated with the fluid supply package. The CPU is operatively coupled with the pressure transducer 618 by pressure transducer signal transmission line 624, in which monitored pressure output signals are transmitted by the transducer to the CPU.

The CPU is correspondingly programmatically arranged to respond to the pressure output signals from pressure transducer 618, by generating responsive control output signals to modulate the set points of the adjustable set point regulators. Thus, the CPU is coupled by a wired connection 626 to the external adjustable regulator 616, and is arranged to generate a wireless control signal 628 that is received by the regulator adjustment mechanism 592 on the valve head and regulator assembly 584 of the fluid supply vessel. In such manner, the set points of one or both of external pressure regulators 590 and 616 may be modulated in response to the monitored pressure of the dispensed gas in the dispensing gas line 614.

It will be recognized that in lieu of the specific arrangement shown in FIG. 19, the valve head assembly of the fluid supply package 580 may comprise a valve head that is not integrated with an external pressure regulator, and in which external pressure regulator 616 is the only external pressure regulator in the overall system. Thus the illustrated system may be substantially varied, as regards the number of internal pressure regulators in the fluid supply vessel, as well as the number of external pressure regulators in the overall fluid delivery system.

Further, as discussed above, the structural composition of the fluid dispensing sticks 600 may be widely varied, as regards the constituent components employed in such gas stick, and such components may include pressure regulators, pressure-actuated check valves, restricted flow orifice (RFO) devices, frit devices, filters, particle occlusion membranes, capillary tube assemblies, etc.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1-21. (canceled)

22. A fluid supply package comprising a fluid supply vessel coupled to a valve head including a discharge port configured for dispensing gas from the package, in which the fluid supply vessel includes in an interior volume thereof a fluid dispensing assembly comprising one or more pressure regulator device(s), in a series arrangement when more than one such device is present, and a capillary tube assembly upstream of the pressure regulator device(s) comprising capillary tubes through which gas is flowed to the pressure regulator device(s), so that gas flows from the pressure regulator device(s) to the valve head for dispensing at a discharge port thereof, and wherein the interior volume of the fluid supply vessel also contains adsorbent as a storage medium for the gas, on which the gas is stored and from which gas is desorbed under dispensing conditions.

23. The fluid supply package of claim 22, wherein the pressure regulator device(s) comprise a pressure regulator device selected from the group consisting of set point pressure regulator devices and pressure-actuated check valves.

24. The fluid supply package of claim 22, wherein the adsorbent comprises a vertical stack of disk-shaped adsorbent articles in which adjacent discs abut each other in face-to-face contact in the stack.

25-33. (canceled)

34. A fluid supply package comprising a pressure-regulated fluid supply vessel coupled to a valve head, wherein the pressure regulated fluid supply vessel contains in an interior volume of the vessel a fluid dispensing assembly comprising a series arrangement of pressure regulators, in which the regulators are configured to provide dispensed fluid from the fluid supply package at pressure at or slightly above atmospheric pressure, thereby obviating the need for a vacuum process or pump to boost the dispensed gas pressure and drive the gas flow, and wherein a restrictive flow orifice is optionally provided in a gas flow passage of a valve in the valve head of the fluid supply package.

35. The fluid supply package of claim 34, wherein the series arrangement of pressure regulators is configured to provide dispensed fluid from the fluid supply package at pressure of 800 to 1000 torr.

36. The fluid supply package of claim 34, as coupled to gas flow circuitry for delivery of dispense gas to a gas-utilizing system operating at or slightly above atmospheric pressure, wherein the gas flow circuitry does not contain (i) a pressure booster device for driving the gas flow from the fluid supply package to the gas-utilizing system, or (ii) an external regulator in the gas flow circuitry.

37. A fluid supply package of a type selected from the group consisting of adsorbent-based fluid supply packages, pressure-regulated fluid supply packages, and adsorbent-based and concurrently pressure-regulated fluid supply packages, the fluid supply package comprising a fluid supply vessel coupled to a valve head configured for dispensing gas from the fluid supply vessel in dispensing operation of the fluid supply package, and the fluid supply package containing co-packaged implant dopant gases in the fluid supply vessel, wherein the co-packaged implant dopant gases do not include elements in respective gases that will result in cross-contamination in ion implantation operation utilizing gas dispensed from the fluid supply package.

38. The fluid supply package of claim 37, in which the pressure-regulated fluid supply package comprises at least one pressure regulator device in a dispensed gas flow path in an interior volume of the fluid supply vessel of the package.

39. (canceled)

40. The fluid supply package of claim 37, wherein the co-package implant dopant gases comprise a gas mixture selected from the group consisting of: AsH₃/PH₃; AsH₃/SiH₄; PH₃/GeH₄; AsH₃/SiH₄/PH₃; BF₃/GeF₄; SiF₄/GeF₄; SiF₄/BF₃; SiF₄/BF₃/GeF₄; CO₂/AsH₃; CO₂/PH₃; CO₂/BF₃; CO₂/GeF₄; and CO₂/SiF₄.

41. The fluid supply package of claim 37, wherein the fluid supply package is of a type selected from the group consisting of adsorbent-based fluid supply packages, and adsorbent-based and concurrently pressure-regulated fluid supply packages, wherein the adsorbent comprises multiple adsorbent species, each of which is selective for one of the co-packaged implant dopant gases.

42-43. (canceled)

44. A fluid supply package including a pressure-regulated fluid supply vessel coupled to a valve head for dispensing of gas at a predetermined pressure level, and comprising a gas dispensing assembly in an interior volume of the fluid supply vessel, the gas dispensing assembly comprising a gas stick defining a gas flow path including at least one flow control device, wherein an upper portion of the gas stick is coaxial with the fluid supply vessel and a lower portion of the gas stick comprises a conduit that is angled away from the coaxial upper portion of the gas stick and is coupled at a lower end thereof to a gas-permeable membrane for occlusion of particles from gas flowed through the gas stick for dispensing from the fluid supply package.

45. The fluid supply package of claim 44, wherein the at least one flow control device in the gas stick is selected from the group consisting of pressure regulators and pressure actuated check valves.

46. The fluid supply package of claim 44, wherein the angled lower portion of the gas stick is angled away from the coaxial upper portion of the gas stick so as to define an included angle between the axis of the coaxial upper portion of the gas stick and the angled lower portion of the gas stick, that is in a range of from 10° to 25°.

47-64. (canceled)

65. A fluid supply package comprising a fluid supply vessel coupled to a valve head for dispensing of fluid from the fluid supply vessel, wherein the valve head comprises a pneumatic valve and is dimensionally sized to enable placement of the fluid supply package in an ion implanter gas box.

66. The fluid supply package of claim 65, comprising an adsorbent-based fluid supply vessel.

67. The fluid supply package of claim 65, as installed in an ion implanter gas box.

68-95. (canceled)
